(19) United States
(12) Patent Application Publication
(10) Pub. No.: US 2005/0123791 A1
(43) Pub. Date: Jun. 9, 2005

(54) Organic electroluminescent devices

(76) Inventors: Joseph C. Deaton, Rochester, NY (US); Tukaram K. Hatwar, Penfield, NY (US); Denis Y. Kondakov, Kendall, NY (US); Christopher T. Brown, Rochester, NY (US)

Correspondence Address: Paul A. Leipold;Patent Legal Staff, Eastman Kodak Company, 343 State Street, Rochester, NY, 14650-2201, US

(21) Appl. No.: 10/729,328

(22) Filed: Dec. 5, 2003

(51) Int. Cl. H05B 33/14

(52) U.S. Cl. 428/690; 428/917; 313/504; 313/506; 313/112; 257/98

(57) ABSTRACT

Disclosed is an electroluminescent device comprising a cathode and anode, and therebetween, at least two light-emitting layers wherein the first layer, layer A, comprises a phosphorescent light-emitting organometallic compound comprising iridium and an isoquinoline group and a second layer, layer B, comprising a light-emitting material. Such devices provide useful white light emissions.

### FIELD OF THE INVENTION

This invention relates to an organic light-emitting diode (OLED) electroluminescent (EL) device comprising a cathode and anode, and therebetween, at least two light-emitting layers wherein the first layer, layer A, comprises a phosphorescent light-emitting organometallic compound comprising iridium and an isoquinoline group and a second layer, layer B, comprising a light-emitting material.

### BACKGROUND OF THE INVENTION

While organic electroluminescent (EL) devices have been known for over two decades, their performance limitations have represented a barrier to many desirable applications. In simplest form, an organic EL device is comprised of an anode for hole injection, a cathode for electron injection, and an organic medium sandwiched between these electrodes to support charge recombination that yields emission of light. These devices are also commonly referred to as organic light-emitting diodes, or OLEDs. Representative of earlier organic EL devices are Gurnee et al. U.S. Pat. No. 3,172,862, issued Mar. 9, 1965; Gurnee U.S. Pat. No. 3,173,050, issued Mar. 9, 1965; Dresner, “Double Injection Electroluminescence in Anthracene”, RCA Review, Vol. 30, pp. 322-334, 1969; and Dresner U.S. Pat. No. 3,710,167, issued Jan. 9, 1973. The organic layers in these devices, usually composed of a polycyclic aromatic hydrocarbon, were very thick (much greater than 1 μm). Consequently, operating voltages were very high, often >100V.

More recent organic EL devices include an organic EL element consisting of extremely thin layers (e.g. <1.0 μm) between the anode and the cathode. Herein, the term “organic EL element” encompasses the layers between the anode and cathode electrodes. Reducing the thickness lowered the resistance of the organic layer and has enabled devices that operate much lower voltage. In a basic two-layer EL device structure, described first in U.S. Pat. No. 4,356,429, one organic layer of the EL element adjacent to the anode is specifically chosen to transport holes, therefore, it is referred to as the hole-transporting layer, and the other organic layer is specifically chosen to transport electrons, referred to as the electron-transporting layer. Recombination of the injected holes and electrons within the organic EL element results in efficient electroluminescence.

There have also been proposed three-layer organic EL devices that contain an organic light-emitting layer (LEL) between the hole-transporting layer and electron-transporting layer, such as that disclosed by Tang et al [J. Applied Physics, 65, 3610-3616, (1989)]. The light-emitting layer commonly consists of a host material doped with a guest material Still further, there has been proposed in U.S. Pat. No. 4,769,292 a four-layer EL element comprising a hole-injecting layer (HIL), a hole-transporting layer (HTL), a light-emitting layer (LEL) and an electron-transporting/injectioning layer (ETL). These structures have resulted in improved device efficiency.

Many emitting materials that have been described as useful in an OLED device emit light from their excited singlet state by fluorescence. The excited singlet state is created when excitons formed in an OLED device transfer their energy to the excited state of the dopant. However, it is generally believed that only 25% of the excitons created in an EL device are singlet excitons. The remaining excitons are triplet, which cannot readily transfer their energy to the singlet excited state of a dopant. This results in a large loss in efficiency since 75% of the excitons are not used in the light emission process.

Triplet excitons can transfer their energy to a dopant if it has a triplet excited state that is low enough in energy. If the triplet state of the dopant is emissive it can produce light by phosphorescence, wherein phosphorescence is a luminescence involving a change of spin state between the excited state and the ground state. In many cases singlet excitons can also transfer their energy to lowest singlet excited state of the same dopant. The singlet excited state can often relax, by an intersystem crossing process, to the emissive triplet excited state. Thus, it is possible, by the proper choice of host and dopant, to collect energy from both the singlet and triplet excitons created in an OLED device and to produce a very efficient phosphorescent emission.

One class of useful phosphorescent materials are transition metal complexes having a triplet excited state. For example, fac-tris(2-phenylpyridinato-N,C^{2′})iridium(III) (Ir(ppy)₃) strongly emits green light from a triplet excited state owing to the large spin-orbit coupling of the heavy atom and to the lowest excited state which is a charge transfer state having a Laporte allowed (orbital symmetry) transition to the ground state (K. A. King, P. J. Spellane, and R. J. Watts, J. Am. Chem. Soc., 107, 1431 (1985), M. G. Colombo, T. C. Brunold, T. Reidener, H. U. Gudel, M. Fortsch, and H.-B. Burgi, Inorg. Chem., 33, 545 (1994)). Small-molecule, vacuum-deposited OLEDs having high efficiency have also been demonstrated with Ir(ppy)₃ as the phosphorescent material and 4,4′-N,N′-dicarbazole-biphenyl (CBP) as the host (M. A. Baldo, S. Lamansky, P. E. Burrows, M. E. Thompson, S. R. Forrest, Appl. Phys. Lett., 75, 4 (1999), T. Tsutsui, M.-J. Yang, M. Yahiro, K. Nakamura, T. Watanabe, T. Tsuji, Y. Fukuda, T. Wakimoto, S. Miyaguchi, Jpn. J Appl. Phys., 38, L1502 (1999)).

Another class of phosphorescent materials include compounds having interactions between atoms having d¹⁰ electron configuration, such as Au₂(dppm)Cl₂ (dppm=bis(diphenylphosphino)methane) (Y. Ma et al, Appl. Phys. Lett., 74, 1361 (1998)). Still other examples of useful phosphorescent materials include coordination complexes of the trivalent lanthanides such as Tb³⁺ and Eu³⁺ (J. Kido et al, Appl. Phys. Lett., 65, 2124 (1994)). While these latter phosphorescent compounds do not necessarily have triplets as the lowest excited states, their optical transitions do involve a change in spin state of 1 and thereby can harvest the triplet excitons in OLED devices.

Phosphorescent materials can also be useful in electroluminescent devices that produce white light. Electroluminescent devices (such as OLEDs) that produce white light efficiently are considered a low cost alternative for several applications such as paper-thin light sources, backlights in liquid crystal displays (LCDs), automotive dome lights, and office lighting. As with any light-emitting device, it is desirable that white EL devices be bright and efficient in terms of power consumption. The preferred spectrum and precise color of a white EL device will depend on the application for which it is intended. For example, if a particular application requires light that is to be perceived as white without subsequent processing that alters the color perceived by a viewer, it is desirable that the light emitted by the EL device have 1931 Commission International d'Eclairage (CIE) chromaticity coordinates, (CIEx, CIEy), of about (0.33, 0.33). For other applications, particularly applications in which the light emitted by the EL device is subjected to further processing that alters its perceived color, it can be satisfactory or even desirable for the light that is emitted by the EL device to be off-white, for example bluish white, greenish white, yellowish white, or reddish white. Hereinafter, the term “white” will be used broadly to mean light that is perceived as white or off-white. The CIE coordinates of such light satisfy, at least approximately, the condition that the quantities (CIEx+0.64 CIEy) and (0.64 CIEx−CIEy) be in the range of 0.36 to 0.76 and the range of −0.20 to +0.01, respectively. A white EL device will mean an EL device, such as a white OLED device, whose emission is white in this broad sense.

The following patents and publications disclose EL devices capable of emitting white light, comprising a hole-transporting layer and an organic luminescent layer, and interposed between two electrodes. White OLEDs have been reported by J. Shi in U.S. Pat. No. 5,683,823, wherein the luminescent layer includes red and blue light-emitting materials uniformly dispersed in a host emitting material. These devices have good electroluminescent characteristics, but the concentrations of the red and blue dopants are very small, such as 0.12% and 0.25% of the host material. These concentrations are difficult to control during large-scale manufacturing. Sato et al., in JP 07,142,169, disclose an OLED capable of emitting white light, made by forming a blue light-emitting layer adjacent to a hole-transporting layer, followed by a green light-emitting layer having a region containing a red fluorescent dye. Kido et al., in Applied Physics Letters Vol., 64, 815 (1994), report a white EL device in which a single light-emitting layer contains a polymeric host and three fluorescent dyes emitting in different spectral regions. Kido et al., in Science, 267, 1332 (1995), report another white OLED. In this device, three light-emitting layers with different carrier transport properties, and individually emitting blue, green or red light, are used to generate white light. Littman et al., in U.S. Pat. No. 5,405,709, disclose another white OLED that includes an electron-transporting layer doped with a red dopant and also includes a blue light-emitting recombination layer contiguous with a hole-injecting and hole-transporting zone. Deshpande et al., in Applied Physics Letters, 75, 888 (1999), describe a white OLED using one layer with green luminescence and a second layer with red and blue luminescence, the two layers being separated by a hole blocking layer.

White EL devices can be used with color filters in full-color display devices. They can also be used with color filters in other multicolor or functional-color display devices. White EL devices for use in such display devices are easy to manufacture, and they produce reliable white light in each pixel of the displays. However, the color filters each transmit only about 30% of the original white light. Therefore, the white EL devices must have high luminous yield. Although the OLEDs are referred to as white and can appear white or off-white, for this application, the CIE coordinates of the light emitted by the OLED are less important than the requirement that the spectral components passed by each of the color filters be present with sufficient intensity in that light. It is also important that the color, after passage through a color filter, be appropriate for the intended application. For use in a full-color display, typical desired colors after passage through a red, green, or blue filter are, respectively, red with CIE coordinates of about (0.64, 0.36), green with CIE coordinates of about (0.29, 0.67), and blue with CIE coordinates of about (0.15, 0.19). The devices must also have good stability in long-term operation. That is, as the devices are operated for extended periods of time, the luminance of the devices should decrease as little as possible.

White emitting OLEDs have also been prepared using two triplet emitting dopants in a single emissive layer as described in the U.S. patent application US 2003/0124381 A1. Although triplet emitters are efficient with quantum efficiencies exceeding 8%, the white emitting light described in this application has efficiencies of less than 5%. Also color from these devices has an orange hue, with CIEx=0.34-0.39 and CIEy=0.45-0.47.

Also there is a problem in the application of white OLEDs, when used with color filters, in that the intensity of the red, green or blue component of the emission spectrum is frequently lower than desired due to the low transmission of the band pass filter. Therefore, passing the white light from the OLED through the R, G, B filters provides R, G, B light with a lower efficiency than desired, and the power that is required to provide a desired intensity is higher than desired. Consequently, the power that is required to produce a white color in the display by mixing red, green, and blue light can also be higher than desired.

Thus there is a need for a improving the efficiency of these white-emitting EL devices based on the triplet materials. It is a problem to be solved to provide white-emitting EL device structure based on phosphorescent light-emitting materials that can provide useful white light emissions.

### SUMMARY OF THE INVENTION

The invention provides an electroluminescent device comprising a cathode and anode, and therebetween, at least two light-emitting layers wherein the first layer, layer A, comprises a phosphorescent light-emitting organometallic compound comprising iridium and an isoquinoline group and a second layer, layer B, comprising a light-emitting material. The invention also provides a display and an area lighting device incorporating the electroluminescent device.

Such devices provide useful white light emissions.

### BRIEF DESCRIPTION OF THE DRAWINGS

FIG. 1 shows a schematic cross-section of a typical OLED device in which this invention may be used. Since device feature dimensions such as layer thicknesses are frequently in sub-micrometer ranges and can vary over wide ranges, the drawings are scaled for ease of visualization rather than dimensional accuracy.

### DETAILED DESCRIPTION OF THE INVENTION

The invention comprises an electroluminescent device comprising a cathode, and anode, and therebetween at least two light-emitting layers, wherein the first layer; layer A, comprises a phosphorescent light-emitting organometallic compound comprising iridium and an isoquinoline group and a second layer, layer B, comprises a light-emitting material. The layers may independently emit different colors of light, such as blue, blue-green, green, green-red, yellow, orange, or red light, however, it is an object of the present invention to produce a white electroluminescent device that, when used with the appropriate red, green, and blue color filters, produces white light with good efficiency and color purity.

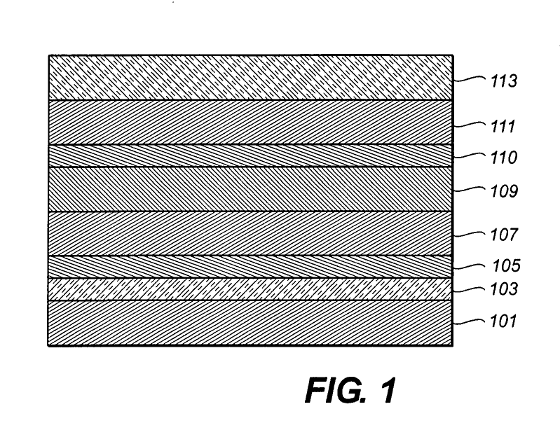

In FIG. 1, a light-emitting layer (LEL) 109 is provided between hole-transporting layer 107 and hole-blocking layer 110. In a desirable embodiment, the LEL is further divided into at least two additional layers. Layer A includes a phosphorescent material that emits light. Layer B may includes a fluorescent light-emitting material, a phosphorescent light-emitting material or both. In one suitable embodiment, Layer A is located on the anode side of the LEL. Alternatively, in another desirable embodiment, Layer B is located on the anode side. The LEL may be further divided into additional layers.

As more fully described in U.S. Pat. Nos. 4,769,292 and 5,935,721, the LEL of the organic EL element includes luminescent materials where electroluminescence is produced as a result of electron-hole pair recombination in this region. The light-emitting layers consist of host materials doped with guest light-emitting materials wherein light emission comes primarily from the emitting materials.

Phosphorescent Light-Emitting Materials

Layer A includes a phosphorescent light-emitting organometallic compound comprising iridium and an isoquinoline group. In one desirable embodiment the isoquinoline group is substituted with an aromatic group in the 3-position, which further bonds to iridium. Suitably the isoquinoline group is a 3-arylisoquinoline group. Phosphorescent light-emitting materials of this type can provide a device with good operational stability.

In one suitable embodiment Formula 1 represents the organometallic compound.

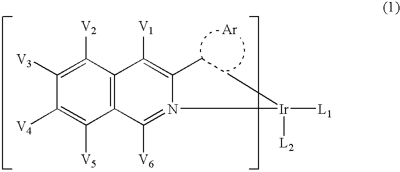

In Formula 1, Ar represents the atoms necessary to complete a five or six-membered aromatic ring, such a phenyl group. L₁ and L₂ represent bidentate ligands. A bidentate ligand has two binding sites to the metal, for example a 2-phenylpyridine group or an acetylacetonate group. V₁-V₆ each independently represent hydrogen or an independently selected substituent, such as a methyl group or phenyl group. Adjacent substituents can join together to form a ring, for example, a fused benzene ring group.

In one suitable embodiment Formula 2 represents the organometallic compound.

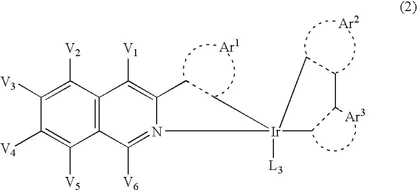

In Formula 2, Ar¹ and Ar² independently represent the atoms necessary to complete a five or six-membered aromatic ring, such as a phenyl ring group. Ar³ represents the atoms necessary to complete a five or six-membered heteroaromatic ring group, such as a pyridine ring group. L₃ represents a bidentate ligand. V₁-V₆ were described previously. In one desirable embodiment, L3 represents a 3-arylisoquinoline group.

In another suitable embodiment, Formula 3 represents the organometallic compound.

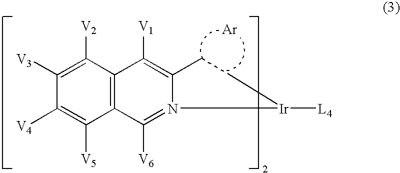

In Formula 3, L₄ represents a ligand comprising a pyridine group substituted with a five or six-member aromatic group, such as a phenyl ring group, and wherein Ir bonds to both the pyridine group and the aromatic group. Ar and V₁-V₆ were described previously. These materials may afford lower sublimation temperatures as well as improved stability.

In another desirable embodiment the organometallic compound is represented by Formula 4. In Formula 4, Ar and V₁-V₆ were described previously.

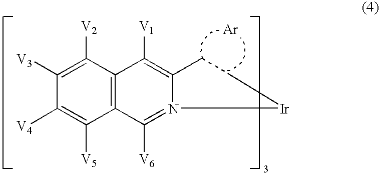

Illustrative examples of useful phosphorescent light-emitting materials are listed below.

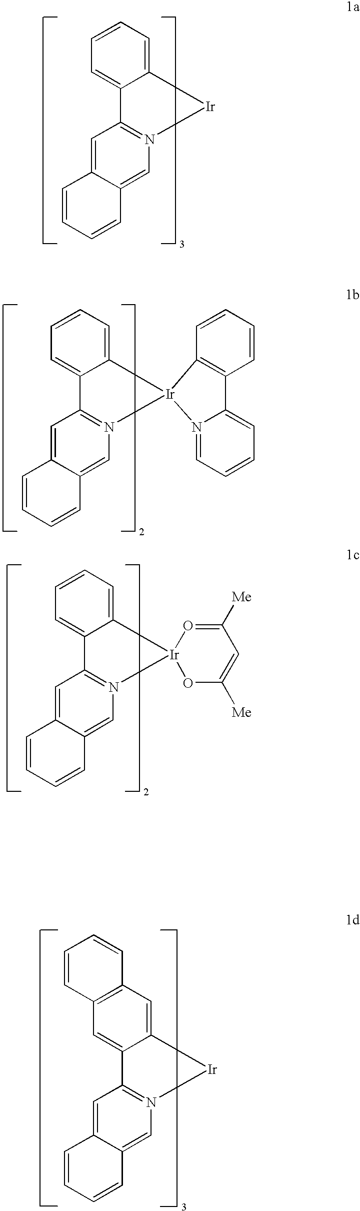

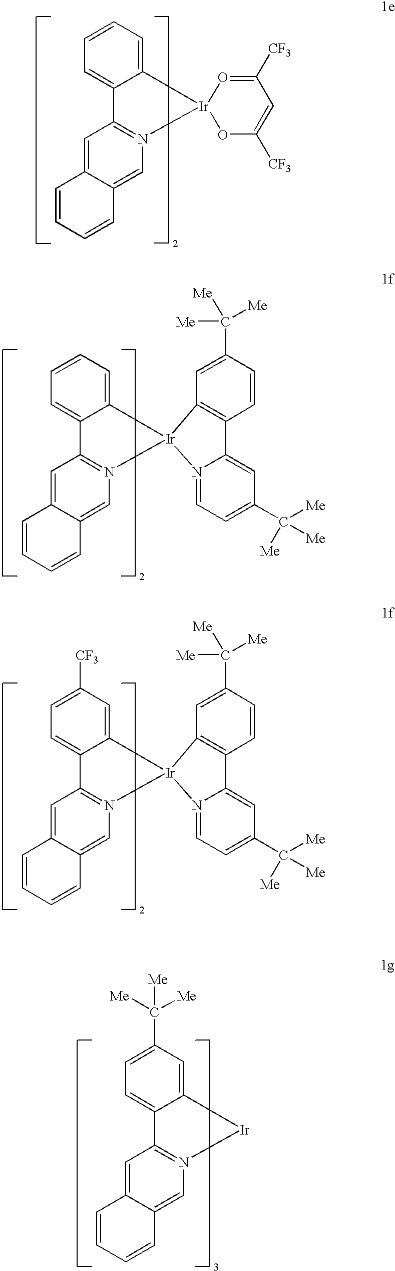

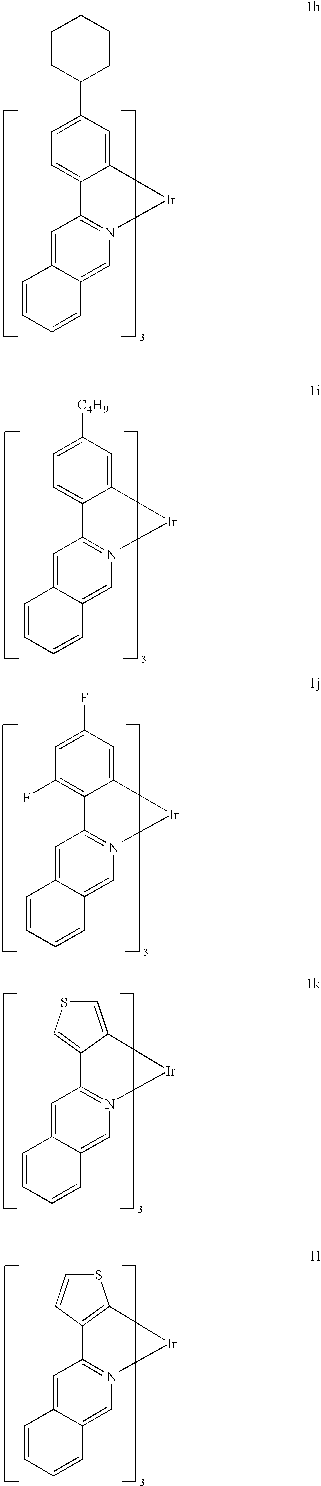

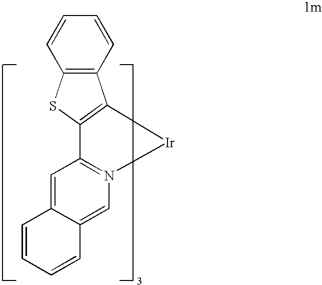

Suitably, layer A of the device comprises a host material and one or more guest phosphorescent materials for emitting light. In one embodiment, layer B of the device may also include one or more guest phosphorescent light-emitting materials and a host material. The phosphorescent light-emitting guest material(s) is usually present in an amount less than the amount of host materials and is typically present in an amount of up to 20 wt % of the host, more typically from 2-10.0 wt % of the host For convenience, the phosphorescent complex guest material may be referred to herein as a phosphorescent material. The phosphorescent material is suitably a low molecular weight compound, but it may also be an oligomer or a polymer having a main chain or a side chain of repeating units having the phosphorescent moiety present. The phosphorescent material may be provided as a discrete material dispersed in the host material, or it may be bonded in some way to the host material, for example, covalently bonded into a polymeric host.

In one suitable embodiment, layer B includes a phosphorescent light-emitting material that comprises an organometallic complex comprising a metal selected from the group consisting of Ir, Rh, Ru, Pt, and Pd and at least one organic ligand.

Synthesis of organometallic complexes may be accomplished by preparing an organic ligand and then using a metal to complex the ligand and form the organometallic compound. The synthesis of ligands useful in the invention may be accomplished by various methods found in the literature, for example see Huang et al., J. Org. Chem. 67, 3437 (2000) and N. Chatterjea, S. Shaw, Y. Prasad, R. Singh, J. Ind. Chem. Soc., 61, 1028 (1984).

Phosphorescent light-emitting organometallic complexes useful in the invention may be synthesized from the prepared ligands by various literature methods. For example, see A. Tamayo, B. Alleyne, P. Djurovich, S. Lamansky, I. Tsyba, N. Ho, R. Bau, M. Thompson, J. of the Amer. Chem. Soc., 125, 7377 (2003), H. Konno,Y. Sasaki, Chem. Lett., 32, 252 (2003), and V. Grushin, N. Hurron, D. LeCloux, W. Marshall, V. Petrov, and Y. Wang, Chem. Comm., 1494 (2001).

Host Materials for Phosphorescent Materials

Suitable host materials should be selected so that the triplet exciton can be transferred efficiently from the host material to the phosphorescent material. For this transfer to occur, it is a highly desirable condition that the excited state energy of the phosphorescent material be lower than the difference in energy between the lowest triplet state and the ground state of the host. However, the band gap of the host should not be chosen so large as to cause an unacceptable increase in the drive voltage of the electroluminescent device. Suitable host materials are described in WO 00/70655 A2; 01/39234 A2; 01/93642 A1; 02/074015 A2; 02/15645 A1, and U.S. 2002/0117662. Suitable hosts include certain aryl amines, triazoles, indoles and carbazole compounds. Examples of desirable hosts are 4,4′-N,N′-dicarbazole-biphenyl (CBP), 2,2′-dimethyl-4,4′-N,N′-dicarbazole-biphenyl, 1,3-di(N,N′-dicarbazole)benzene, and poly(N-vinylcarbazole), including their derivatives.

Desirable host materials are capable of forming a continuous film. The light-emitting layers may each contain more than one host material in order to improve the device's film morphology, electrical properties, light emission efficiency, and lifetime. The light-emitting layers may each contain a first host material that has good hole-transporting properties, and a second host material that has good electron-transporting properties.

Other Phosphorescent Materials

Phosphorescent materials may be used alone or may be used in combination with other phosphorescent materials, either in the same or different layers. Some other phosphorescent and related materials are described in WO 00/57676, WO 00/70655, WO 01/41512 A1, WO 02/15645 A1, U.S. 2003/0017361 A1, WO 01/93642 A1, WO 01/39234 A2, U.S. Pat. No. 6,458,475 B1, WO 02/071813 A1, U.S. Pat. No. 6,573,651 B2, U.S. 2002/0197511 A1, WO 02/074015 A2, U.S. Pat. No. 6,451,455 B1, U.S. 2003/0072964 A1, US 2003/0068528 A1, U.S. Pat. No. 6,413,656 B1, U.S. Pat. No. 6,515,298 B2, U.S. Pat. No. 6,451,415 B1, U.S. Pat. No. 6,097,147, U.S. 2003/0124381 A1, U.S. 2003/0059646 A1, U.S. 2003/0054198 A1, EP 1 239 526 A2, EP 1 238 981 A2, EP 1 244 155 A2, U.S. 2002/0100906 A1, US 2003/0068526 A1, U.S. 2003/0068535 A1, JP 2003073387A, JP 2003 073388A, U.S. 2003/0141809 A1, U.S. 2003/0040627 A1, JP 2003/059667A, JP 2003/073665A, and U.S. 2002/0121638 A1.

The emission wavelengths of cyclometallated Ir(III) complexes of the type IrL₃ and IrL₂L′, such as the green-emitting fac-tris(2-phenylpyridinato-N,C^{2′})Iridium(III) and bis(2-phenylpyridinato-N,C^{2′})Iridium(III)(acetylacetonate) may be shifted by substitution of electron donating or withdrawing groups at appropriate positions on the cyclometallating ligand L, or by choice of different heterocycles for the cyclometallating ligand L. The emission wavelengths may also be shifted by choice of the ancillary ligand L′. Examples of red emitters are the bis(2-(2′-benzothienyl)pyridinato-N,C^{3′})Iridium(III)(acetylacetonate) and tris(1-phenylisoquinolinato-N,C)Iridium(III). A blue-emitting example is bis(2-(4,6-diflourophenyl)-pyridinato-N,C^{2′})Iridium(III)(picolinate).

Still other examples of phosphorescent materials include coordination complexes of the trivalent lanthanides such as Tb³⁺ and Eu³⁺ (J. Kido et al, Appl. Phys. Lett., 65, 2124 (1994))

Blocking Layers

In addition to suitable hosts, an EL device employing a phosphorescent material often requires at least one exciton- or hole- or electron-blocking layers to help confine the excitons or electron-hole recombination centers to the light-emitting layer comprising the host and emitting material. In one embodiment, such a blocking layer would be placed between the electron-transporting layer and the light-emitting layer—see FIG. 1, layer 110. In this case, the ionization potential of the blocking layer should be such that there is an energy barrier for hole migration from the host into the electron-transporting layer, while the electron affinity should be such that electrons pass more readily from the electron-transporting layer into the light-emitting layer comprising host and phosphorescent material. It is further desired, but not absolutely required, that the triplet energy of the blocking material be greater than that of the phosphorescent material. Suitable hole-blocking materials are described in WO 00/70655A2 and WO 01/93642 A1. Two examples of useful materials are bathocuproine (BCP) and bis(2-methyl-8-quinolinolato)(4-phenylphenolato)Aluminum(III) (BAlQ). Metal complexes other than Balq are also known to block holes and excitons as described in U.S. 20030068528. U.S. 20030175553 A1 describes the use of fac-tris(1-phenylpyrazolato-N,C2)iridium(III) (Irppz) in an electron/exciton blocking layer.

Fluorescent Material

In one desirable embodiment layer B includes a fluorescent light-emitting material and a host for that material. Suitably, in one embodiment, layer B may include a blue or blue-green fluorescent light-emitting material. The term fluorescent refers to a material that emits light from a singlet excited state, that is fluorescence is a luminescence that does not involve a change of spin state between the excited state and the ground state. Fluorescent emitting materials are typically incorporated at 0.01 to 10% by weight of the host material.

Desirably Layer B also includes a host compound. The host material can be an electron-transporting material, a hole-transporting material, or another material or combination of materials that support hole-electron recombination. The host and emitting materials can be small non-polymeric molecules or polymeric materials such as polyfluorenes and polyvinylarylenes (e.g., poly(p-phenylenevinylene), PPV). In the case of polymers, small molecule emitting materials can be molecularly dispersed into a polymeric host, or the emitting materials can be added by copolymerizing a minor constituent into a host polymer. Host materials may be mixed together in order to improve film formation, electrical properties, light emission efficiency, lifetime, or manufacturability. The host may comprise a material that has good hole-transporting properties and a material that has good electron-transporting properties.

In one suitable embodiment, layer B includes a fluorescent light-emitting material and a host material. An important relationship for choosing a fluorescent light-emitting material as a guest emitting material and a host is a comparison of the singlet excited state energies of the host and light-emitting material. For efficient energy transfer from the host to the emitting material, a highly desirable condition is that the singlet excited state energy of the emitting material is lower than that of the host material.

Many fluorescent materials that emit blue light are known in the art and are contemplated for use in the practice of the present invention. Particularly useful classes of blue emitters include perylene and its derivatives such as a perylene nucleus bearing one or more substituents such as an alkyl group or an aryl group. A desirable perylene derivative for use as a blue emitting material is 2,5,8,11-tetra-t-butylperylene.

Another useful class of fluorescent materials includes blue-light emitting derivatives of distyrylarenes such as distyrylbenzene and distyrylbiphenyl, including compounds described in U.S. Pat. No. 5,121,029. Among derivatives of distyrylarenes that provide blue luminescence, particularly useful are those substituted with diarylamino groups, also known as distyrylamines. Examples include the general structure 5a and 5b listed below, wherein R₁—R₈ can be the same or different, and individually represent hydrogen or one or more substituents. For example, substituents can be alkyl groups, such as methyl groups, or aryl groups, such as phenyl groups.

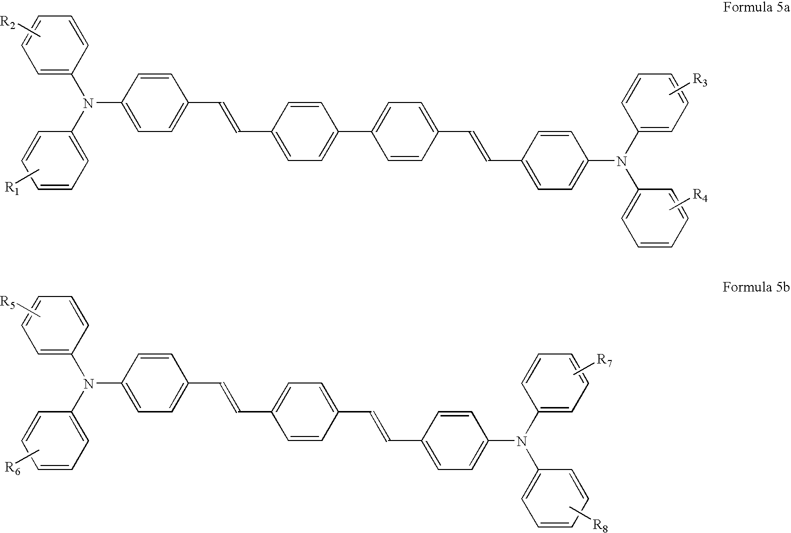

Illustrative examples of useful distyrylamines are blue emitters, 5c and 5b, listed below.

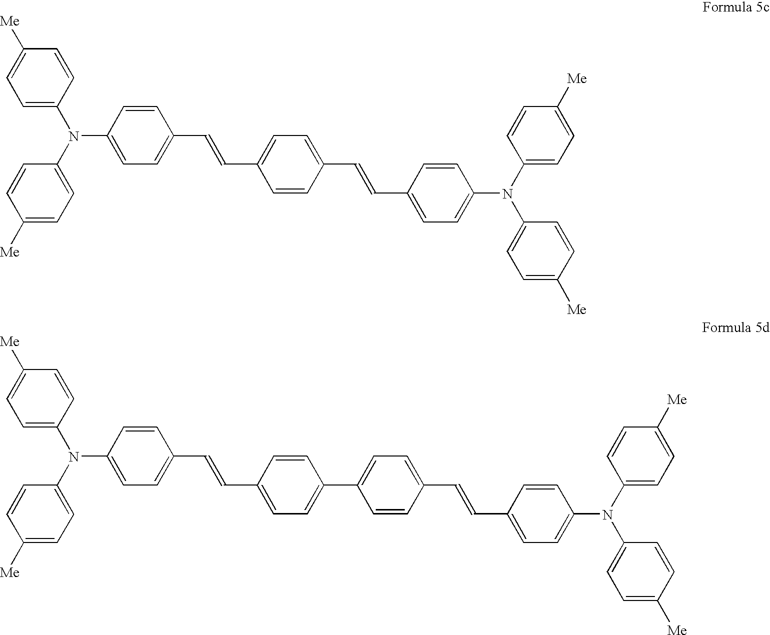

Another useful class of blue emitters comprise a boron atom. Desirable light-emitting materials that contain boron are described in US 2003/0201415. Suitable blue light-emitting materials are represented by Formula 6a.

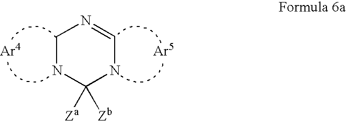

In Formula 6a, Ar⁴ and Ar⁵ independently represent the atoms necessary to form a five or six-membered aromatic ring group, such as a pyridine group. Z^{a} and Z^{b} represent independently selected substituents, such as fluoro substituents.

In one desirable embodiment, useful emitting materials that contain boron are described by Formula 6b.

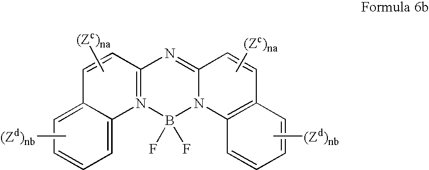

In Formula 6b, Z^{c} and Z^{d} independently represent hydrogen or an independently selected substituent, such as a phenyl group or mesityl group, na independently represents 0, 1, or 2, nb independently represents 0-4.

Illustrative examples of useful boron-containing blue fluorescent materials are listed below.

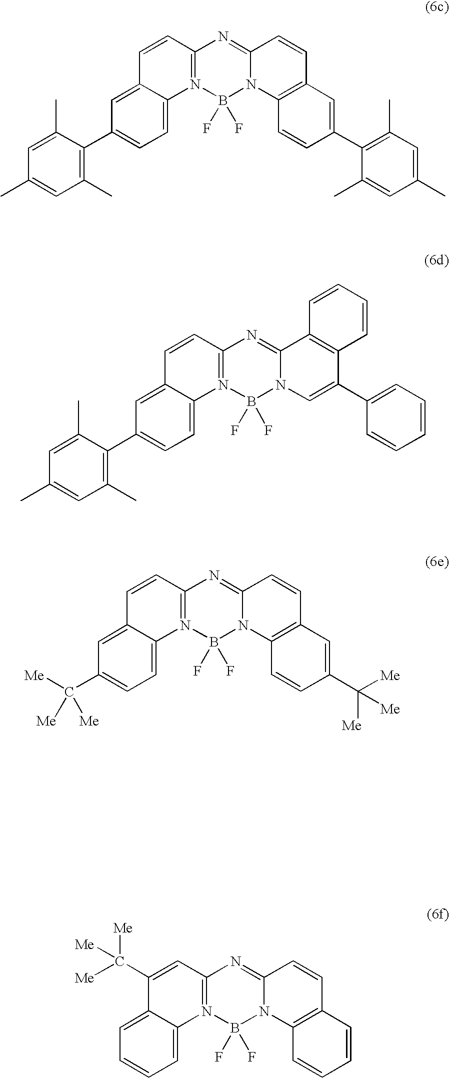

The light-emitting material in layer B can also be a mixture of compounds provided that the mixture emits useful light. Layer B may include one or more additional materials whose principal function is to increase the luminous yield of the device, the stability of the device or both. A class of compounds that increases the luminous yield includes triarylyamines, for example N,N′-di-1-naphthyl-N,N′-diphenyl-4,4′-diaminobiphenyl (NPB).

Other useful fluorescent emitting materials include, but are not limited to, derivatives of anthracene, tetracene, xanthene, rubrene, coumarin, rhodamine, and quinacridone, dicyanomethylenepyran compounds, thiopyran compounds, polymethine compounds, pyrilium and thiapyrilium compounds, fluorene derivatives, periflanthene derivatives, indenoperylene derivatives, bis(azinyl)methane compounds, and carbostyryl compounds. Illustrative examples of useful materials include, but are not limited to, the following:

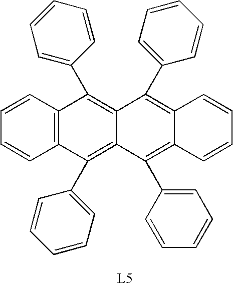

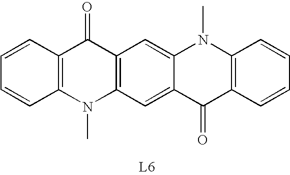

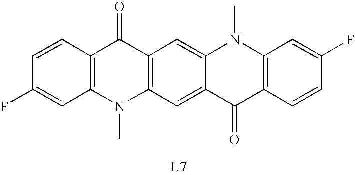

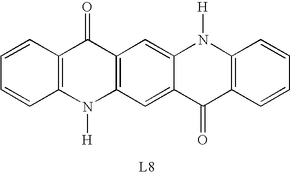

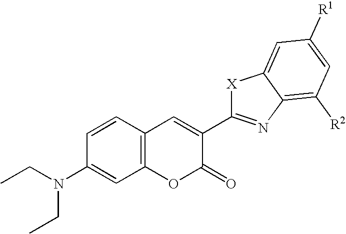

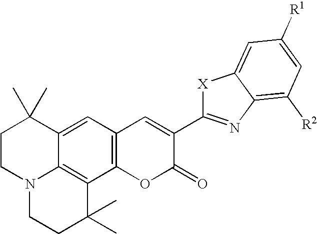

| | X | R1 | R2 |
|---|---|---|---|
| L9 | O | H | H |
| L10 | O | H | Methyl |
| L11 | O | Methyl | H |
| L12 | O | Methyl | Methyl |
| L13 | O | H | t-butyl |
| L14 | O | t-butyl | H |
| L15 | O | t-butyl | t-butyl |
| L16 | S | H | H |
| L17 | S | H | Methyl |
| L18 | S | Methyl | H |
| L19 | S | Methyl | Methyl |
| L20 | S | H | t-butyl |
| L21 | S | t-butyl | H |
| L22 | S | t-butyl | t-butyl |
| L23 | O | H | H |
| L24 | O | H | Methyl |
| L25 | O | Methyl | H |
| L26 | O | Methyl | Methyl |
| L27 | O | H | t-butyl |
| L28 | O | t-butyl | H |
| L29 | O | t-butyl | t-butyl |
| L30 | S | H | H |
| L31 | S | H | Methyl |
| L32 | S | Methyl | H |
| L33 | S | Methyl | Methyl |
| L34 | S | H | t-butyl |
| L35 | S | t-butyl | H |
| L36 | S | t-butyl | t-butyl |

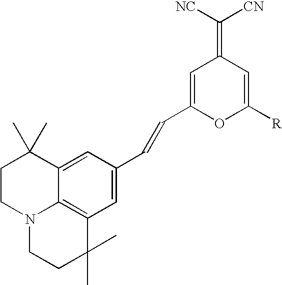

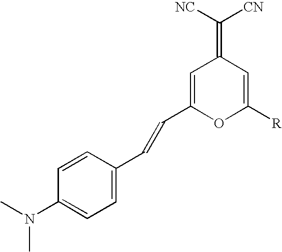

| | R |
|---|---|
| L37 | phenyl |
| L38 | methyl |
| L39 | t-butyl |
| L40 | mesityl |
| L41 | phenyl |
| L42 | methyl |
| L43 | t-butyl |
| L44 | mesityl |

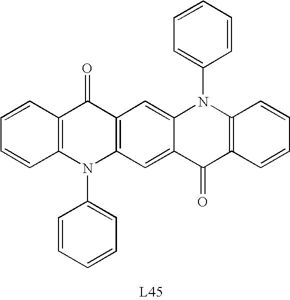

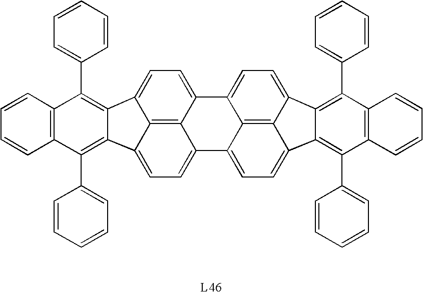

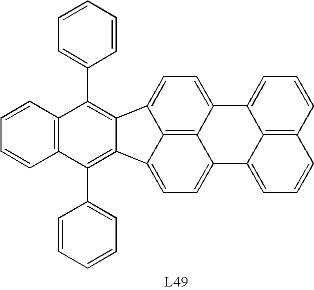

Hosts for Fluorescent Light-Emitting Materials

In one embodiment, layer B includes a florescent light-emitting material and a host. Suitable host materials include carbazole derivatives such as those represented by Formula 7.

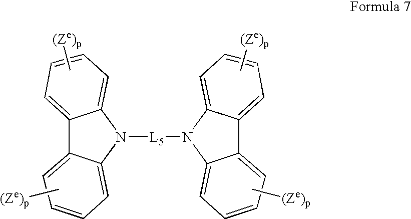

In Formula 7, Z^{e} independently represents hydrogen or an independently selected substituent, such as a methyl group, p independently is 0-4, and L₄ reprsents a phenylene group or a biphenylene group.

In one desirable embodiment the host material is a derivative of anthracene. Suitably, in one embodiment, the host material is represented by Formula 8.

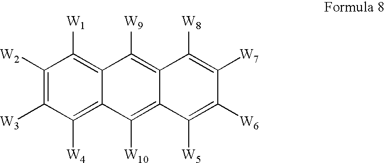

In Formula 8, W₁—W₁₀ represent hydrogen or an independently selected substituent, such as an alkyl group or an aryl group. Adjacent substituents may also join together to form rings, such as a benzene ring group.

Suitably, useful hosts include derivatives of anthracene having hydrocarbon groups at the 9 and 10 positions (corresponding to W₉ and W₁₀ in Formula 8), such as 9,10-diphenylanthracene and its derivatives, as described in U.S. Pat. No. 5,935,721. Especially desirable hosts for use with fluorescent light-emitting materials include anthracene derivatives substituted with naphthyl groups at the 9,10 position such as 9,10-di-(2-naphthyl)anthracene (ADN) and 2-t-butyl-9,10-di-(2-naphthyl)anthracene (TBADN). Additional desirable hosts include anthracene derivatives substituted with a biphenyl group at the 9 or 10 position, for example, 9-(4-biphenyl)-10-(2-naphthyl)anthracene and 9-(3-biphenyl)-10-(1-naphthyl)anthracene. Desirable hosts also include anthracenes with fused benzene rings, such as 1,2-benzoanthracene, 1,2,3,4-dibenzoanthracene, and 1,2,5,6-dibenzoanthracene.

Styrylarylene derivatives as described in U.S. Pat. No. 5,121,029 and JP 08333569 are also useful hosts for fluorescent light-emitting materials, for example, 9,10-bis[4-(2,2-diphenylethenyl)phenyl]anthracene and 4,4′-bis(2,2-diphenylethenyl)-1,1′-biphenyl.

Additional derivatives of anthracene having substituents at the 9 and 10 positions that are suitable as host materials for use with fluorescent light-emitting materials include bianthryl and trianthryl compounds, as described in U.S. Pat. No. 6,534,199. In these anthracene derivatives, the substituent at the 9 or the substituents at both the 9 and 10 positions include(s) anthracene groups.

Suitable host materials also include derivatives described by Formula 9.

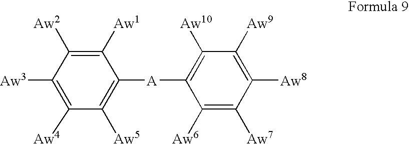

In formula 9, Aw¹-Aw¹⁰ independently represent aromatic groups, such as phenyl groups and naphthyl groups. Suitably, A represents a phenylene group or biphenylene group.

Illustrative examples of useful hosts in Layer A are listed below.

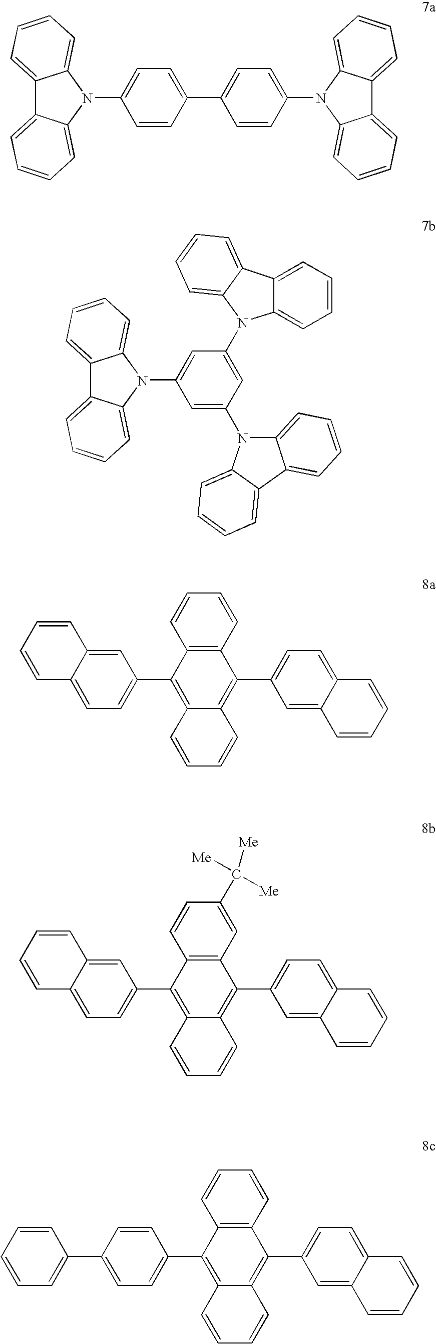

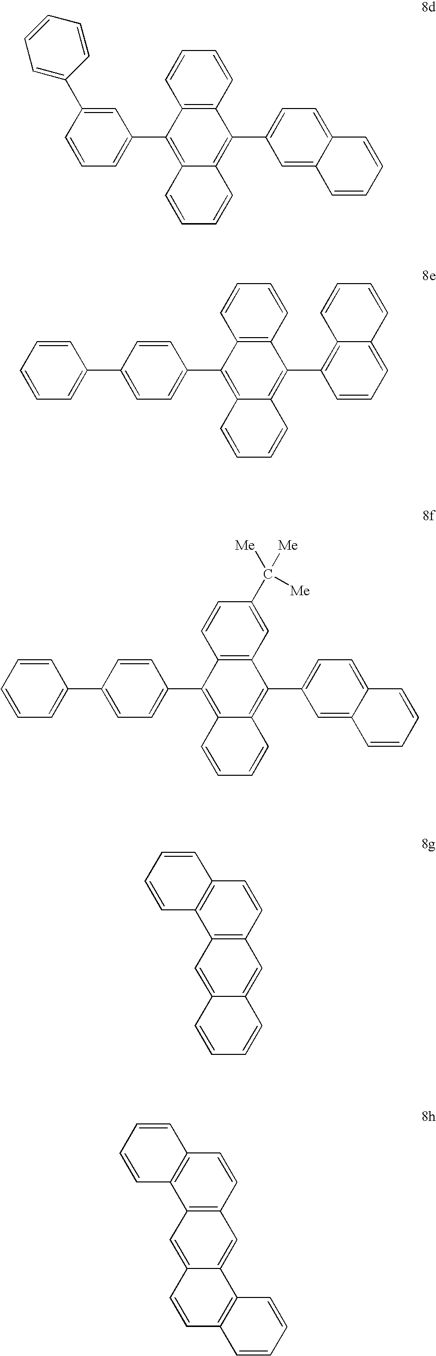

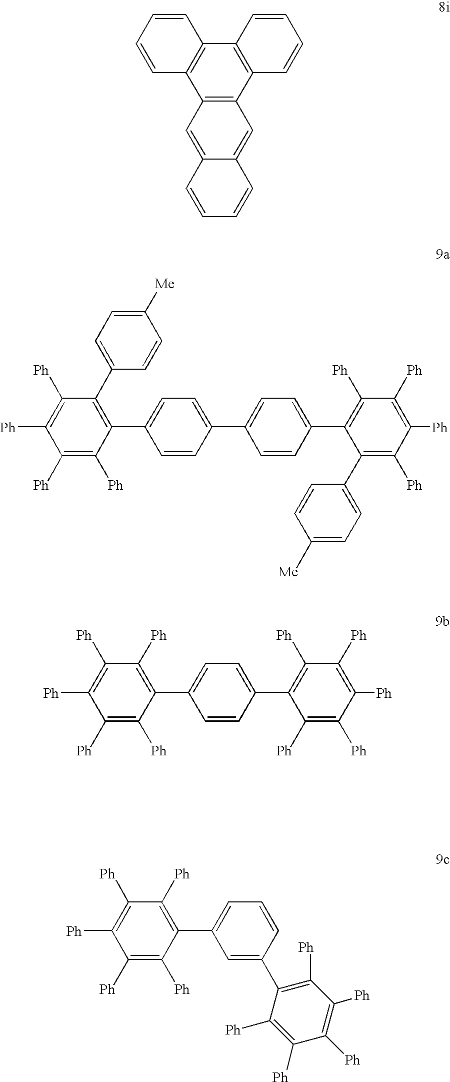

Host and emitting materials known to be of use include, but are not limited to, those disclosed in U.S. Pat. No. 4,768,292, U.S. Pat. No. 5,141,671, U.S. Pat. No. 5,150,006, U.S. Pat. No. 5,151,629, U.S. Pat. No. 5,405,709, U.S. Pat. No. 5,484,922, U.S. Pat. No. 5,593,788, U.S. Pat. No. 5,645,948, U.S. Pat. No. 5,683,823, U.S. Pat. No. 5,755,999, U.S. Pat. No. 5,928,802, U.S. Pat. No. 5,935,720, U.S. Pat. No. 5,935,721, and U.S. Pat. No. 6,020,078.

Metal complexes of 8-hydroxyquinoline and similar derivatives (Formula E) constitute another class of useful host compounds capable of supporting electroluminescence, and are particularly suitable for light emission of wavelengths longer than 500 nm, e.g., green, yellow, orange, and red. 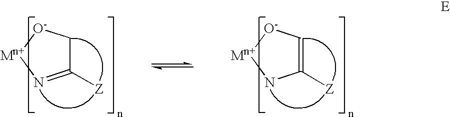
wherein
M represents a metal;
n is an integer of from 1 to 4; and
Z independently in each occurrence represents the atoms completing a nucleus having at least two fused aromatic rings.

From the foregoing it is apparent that the metal can be monovalent, divalent, trivalent, or tetravalent metal. The metal can, for example, be an alkali metal, such as lithium, sodium, or potassium; an alkaline earth metal, such as magnesium or calcium; an earth metal, such aluminum or gallium, or a transition metal such as zinc or zirconium. Generally any monovalent, divalent, trivalent, or tetravalent metal known to be a useful chelating metal can be employed.

Z completes a heterocyclic nucleus containing at least two fused aromatic rings, at least one of which is an azole or azine ring. Additional rings, including both aliphatic and aromatic rings, can be fused with the two required rings, if required. To avoid adding molecular bulk without improving on function the number of ring atoms is usually maintained at 18 or less.

Illustrative of useful chelated oxinoid compounds are the following:
CO-1: Aluminum trisoxine [alias, tris(8-quinolinolato)aluminum(III)]
CO-2: Magnesium bisoxine [alias, bis(8-quinolinolato)magnesium(II)]
CO-3: Bis[benzo{f}-8-quinolinolato]zinc (II)
CO-4: Bis(2-methyl-8-quinolinolato)aluminum(III)-μ-oxo-bis(2-methyl-8-quinolinolato)aluminum(III)
CO-5: Indium trisoxine [alias, tris(8-quinolinolato)indium]
CO-6: Aluminum tris(5-methyloxine) [alias, tris(5-methyl-8-quinolinolato) aluminum(III)]
CO-7: Lithium oxine [alias, (8-quinolinolato)lithium(I)]
CO-8: Gallium oxine [alias, tris(8-quinolinolato)gallium(III)]
CO-9: Zirconium oxine [alias, tetra(8-quinolinolato)zirconium(IV)]
Benzazole derivatives (Formula G) constitute another class of useful host materials capable of supporting electroluminescence, and are particularly suitable for light emission of wavelengths longer than 400 nm, e.g., blue, green, yellow, orange or red. 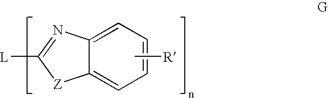
   Where:
n is an integer of 3 to 8;
Z is O, NR or S; and
R and R′ are individually hydrogen; alkyl of from 1 to 24 carbon atoms, for example, propyl, t-butyl, heptyl, and the like; aryl or hetero-atom substituted aryl of from 5 to 20 carbon atoms for example phenyl and naphthyl, furyl, thienyl, pyridyl, quinolinyl and other heterocyclic systems; or halo such as chloro, fluoro; or atoms necessary to complete a fused aromatic ring; and
L is a linkage unit consisting of alkyl, aryl, substituted alkyl, or substituted aryl, which conjugately or unconjugately connects the multiple benzazoles together. An example of a useful benzazole is 2,2′,2″-(1,3,5-phenylene)tris[1-phenyl-1H-benzimidazole].

Depending on the nature of the electron-transporting material and the configuration of the LEL, the blocking layer can be entirely omitted. In one embodiment, blocking layer can be omitted, provided that the electron-transporting layer is adjacent to and in direct contact with the layer including a fluorescent light-emitting material (Layer B).

Embodiments of the invention can provide advantageous features such as operating efficiency, higher luminance, color hue, low drive voltage, and improved operating stability. Embodiments of the organometallic compounds useful in the invention can provide a wide range of hues including those useful in the emission of white light (directly or through filters to provide multicolor displays). In one desirable embodiment the EL device is part of a display device. In another suitable embodiment the EL device is part of an area lighting device.

Color of Light Emitted

In one suitable embodiment, layer A emits yellow light and layer B emits blue light. In another suitable embodiment, layer A emits red light and layer B emits blue-green light.

The color of light emitting materials can be defined more quantitatively by characterizing their emission using the CIE 1931 chromaticity diagram. In this diagram, hue is defined in terms of CIE x and y coordinates. In one desirable embodiment, the phosphorescent material of layer A emits light with color within Sector A of the chromaticity diagram, wherein Sector A is defined by the following relationship between CIE x and CIE y coordinates: 0.24*x+0.26<y<3*x−0.6. For example, a phosphorescent material that emits light with CIE coordinates of (0.55, 0.45) would be suitable for this purpose.

In one embodiment, layer B emits light within Sector B of the chromaticity diagram, wherein Sector B is defined by the following relationship: 2.4*x−0.43<y<−0.077*x+0.35, wherein, x and y are the CIE coordinates of the light emission. For example, light emitted by layer B with CIE color coordinates of (0.15, 0.30) would be suitable for this application.

In one suitable embodiment, the relationship between the CIE color coordinates of light emitted by Layer A and Layer B are defined by equations (1) and (2):
y_{y}>(0.25−y_{b})/(0.31−x_{b})* x_{y}+(y_{b}*0.31−0.25*x_{b})/(0.31−x_{b}) (1)
y_{y}<(0.41−y_{b})/(0.31−x_{b})* x_{y}+(y_{b}*0.31−0.41*x_{b})/(0.31−x_{b}) (2).

In equations 1 and 2, (x_{y}, y_{y}), are the color coordinates of light emitted by Layer (A) and (x_{b}, y_{b}) are the color coordinates of light emitted by Layer (B). For example, a device comprising two light-emitting layers, A and B, wherein Layer A emits light with color CIE (x_{y}, y_{y}) coordinates of (0.54, 0.46) and Layer B emits light with color CIE (x_{b}, y_{b}) coordinates of (0.16, 0.29) would be suitable for this application.

Substituent Definition

Unless otherwise specifically stated, use of the term “substituted” or “substituent” means any group or atom other than hydrogen. Unless otherwise provided, when a group (including a compound or complex) containing a substitutable hydrogen is referred to, it is also intended to encompass not only the unsubstituted form, but also form further substituted derivatives with any substituent group or groups as herein mentioned, so long as the substituent does not destroy properties necessary for utility. Suitably, a substituent group may be halogen or may be bonded to the remainder of the molecule by an atom of carbon, silicon, oxygen, nitrogen, phosphorous, sulfur, selenium, or boron. The substituent may be, for example, halogen, such as chloro, bromo or fluoro; nitro; hydroxyl; cyano; carboxyl; or groups which may be further substituted, such as alkyl, including straight or branched chain or cyclic alkyl, such as methyl, trifluoromethyl, ethyl, t-butyl, 3-(2,4-di-t-pentylphenoxy) propyl, and tetradecyl; alkenyl, such as ethylene, 2-butene; alkoxy, such as methoxy, ethoxy, propoxy, butoxy, 2-methoxyethoxy, sec-butoxy, hexyloxy, 2-ethylhexyloxy, tetradecyloxy, 2-(2,4-di-t-pentylphenoxy)ethoxy, and 2-dodecyloxyethoxy; aryl such as phenyl, 4-t-butylphenyl, 2,4,6-trimethylphenyl, naphthyl; aryloxy, such as phenoxy, 2-methylphenoxy, alpha- or beta-naphthyloxy, and 4-tolyloxy; carbonamido, such as acetamido, benzamido, butyramido, tetradecanamido, alpha-(2,4-di-t-pentyl-phenoxy)acetamido, alpha-(2,4-di-t-pentylphenoxy)butyramido, alpha-(3-pentadecylphenoxy)-hexanamido, alpha-(4-hydroxy-3-t-butylphenoxy)-tetradecanamido, 2-oxo-pyrrolidin-1-yl, 2-oxo-5-tetradecylpyrrolin-1-yl, N-methyltetradecanamido, N-succinimido, N-phthalimido, 2,5-dioxo-1-oxazolidinyl, 3-dodecyl-2,5-dioxo-1-imidazolyl, and N-acetyl-N-dodecylamino, ethoxycarbonylamino, phenoxycarbonylamino, benzyloxycarbonylamino, hexadecyloxycarbonylamino, 2,4-di-t-butylphenoxycarbonylamino, phenylcarbonylamino, 2,5-(di-t-pentylphenyl)carbonylamino, p-dodecyl-phenylcarbonylamino, p-tolylcarbonylamino, N-methylureido, N,N-dimethylureido, N-methyl-N-dodecylureido, N-hexadecylureido, N,N-dioctadecylureido, N,N-dioctyl-N′-ethylureido, N-phenylureido, N,N-diphenylureido, N-phenyl-N-p-tolylureido, N-(m-hexadecylphenyl)ureido, N,N-(2,5-di-t-pentylphenyl)-N′-ethylureido, and t-butylcarbonamido; sulfonamido, such as methylsulfonamido, benzenesulfonamido, p-tolylsulfonamido, p-dodecylbenzenesulfonamido, N-methyltetradecylsulfonamido, N,N-dipropyl-sulfamoylamino, and hexadecylsulfonamido; sulfamoyl, such as N-methylsulfamoyl, N-ethylsulfamoyl, N,N-dipropylsulfamoyl, N-hexadecylsulfamoyl, N,N-dimethylsulfamoyl, N-[3-(dodecyloxy)propyl]sulfamoyl, N-[4-(2,4-di-t-pentylphenoxy)butyl]sulfamoyl, N-methyl-N-tetradecylsulfamoyl, and N-dodecylsulfamoyl; carbamoyl, such as N-methylcarbamoyl, N,N-dibutylcarbamoyl, N-octadecylcarbamoyl, N-[4-(2,4-di-t-pentylphenoxy)butyl]carbamoyl, N-methyl-N-tetradecylcarbamoyl, and N,N-dioctylcarbamoyl; acyl, such as acetyl, (2,4-di-t-amylphenoxy)acetyl, phenoxycarbonyl, p-dodecyloxyphenoxycarbonyl methoxycarbonyl, butoxycarbonyl, tetradecyloxycarbonyl, ethoxycarbonyl, benzyloxycarbonyl, 3-pentadecyloxycarbonyl, and dodecyloxycarbonyl; sulfonyl, such as methoxysulfonyl, octyloxysulfonyl, tetradecyloxysulfonyl, 2-ethylhexyloxysulfonyl, phenoxysulfonyl, 2,4-di-t-pentylphenoxysulfonyl, methylsulfonyl, octylsulfonyl, 2-ethylhexylsulfonyl, dodecylsulfonyl, hexadecylsulfonyl, phenylsulfonyl, 4-nonylphenylsulfonyl, and p-tolylsulfonyl; sulfonyloxy, such as dodecylsulfonyloxy, and hexadecylsulfonyloxy; sulfinyl, such as methylsulfinyl, octylsulfinyl, 2-ethylhexylsulfinyl, dodecylsulfinyl, hexadecylsulfinyl, phenylsulfinyl, 4-nonylphenylsulfinyl, and p-tolylsulfinyl; thio, such as ethylthio, octylthio, benzylthio, tetradecylthio, 2-(2,4-di-t-pentylphenoxy)ethylthio, phenylthio, 2-butoxy-5-t-octylphenylthio, and p-tolylthio; acyloxy, such as acetyloxy, benzoyloxy, octadecanoyloxy, p-dodecylamidobenzoyloxy, N-phenylcarbamoyloxy, N-ethylcarbamoyloxy, and cyclohexylcarbonyloxy; amine, such as phenylanilino, 2-chloroanilino, diethylamine, dodecylamine; imino, such as 1 (N-phenylimido)ethyl, N-succinimido or 3-benzylhydantoinyl; phosphate, such as dimethylphosphate and ethylbutylphosphate; phosphite, such as diethyl and dihexylphosphite; a heterocyclic group, a heterocyclic oxy group or a heterocyclic thio group, each of which may be substituted and which contain a 3 to 7 membered heterocyclic ring composed of carbon atoms and at least one hetero atom selected from the group consisting of oxygen, nitrogen, sulfur, phosphorous, or boron, such as 2-furyl, 2-thienyl, 2-benzimidazolyloxy or 2-benzothiazolyl; quaternary ammonium, such as triethylammonium; quaternary phosphonium, such as triphenylphosphonium; and silyloxy, such as trimethylsilyloxy.

If desired, the substituents may themselves be further substituted one or more times with the described substituent groups. The particular substituents used may be selected by those skilled in the art to attain the desired desirable properties for a specific application and can include, for example, electron-withdrawing groups, electron-donating groups, and steric groups. When a molecule may have two or more substituents, the substituents may be joined together to form a ring such as a fused ring unless otherwise provided. Generally, the above groups and substituents thereof may include those having up to 48 carbon atoms, typically 1 to 36 carbon atoms and usually less than 24 carbon atoms, but greater numbers are possible depending on the particular substituents selected.

General Device Architecture

The present invention can be employed in many OLED device configurations using small molecule materials, oligomeric materials, polymeric materials, or combinations thereof. These include very simple structures comprising a single anode and cathode to more complex devices, such as passive matrix displays comprised of orthogonal arrays of anodes and cathodes to form pixels, and active-matrix displays where each pixel is controlled independently, for example, with thin film transistors (TFTs).

There are numerous configurations of the organic layers wherein the present invention can be successfully practiced. The essential requirements of an OLED are an anode, a cathode, and an organic light-emitting layer located between the anode and cathode. Additional layers may be employed as more fully described hereafter.

A typical structure, especially useful for of a small molecule device, is shown in FIG. 1 and is comprised of a substrate 101, an anode 103, a hole-injecting layer 105, a hole-transporting layer 107, a light-emitting layer 109, a hole- or exciton-blocking layer 110, an electron-transporting layer 111, and a cathode 113. These layers are described in detail below. Note that the substrate may alternatively be located adjacent to the cathode, or the substrate may actually constitute the anode or cathode. The organic layers between the anode and cathode are conveniently referred to as the organic EL element. Also, the total combined thickness of the organic layers is desirably less than 500 nm.

The anode and cathode of the OLED are connected to a voltage/current source through electrical conductors. The OLED is operated by applying a potential between the anode and cathode such that the anode is at a more positive potential than the cathode. Holes are injected into the organic EL element from the anode and electrons are injected into the organic EL element at the cathode. Enhanced device stability can sometimes be achieved when the OLED is operated in an AC mode where, for some time period in the cycle, the potential bias is reversed and no current flows. An example of an AC driven OLED is described in U.S. Pat. No. 5,552,678.

Substrate

The OLED device of this invention is typically provided over a supporting substrate 101 where either the cathode or anode can be in contact with the substrate. The electrode in contact with the substrate is conveniently referred to as the bottom electrode. Conventionally, the bottom electrode is the anode, but this invention is not limited to that configuration. The substrate can either be light transmissive or opaque, depending on the intended direction of light emission. The light transmissive property is desirable for viewing the EL emission through the substrate. Transparent glass or plastic is commonly employed in such cases. The substrate can be a complex structure comprising multiple layers of materials. This is typically the case for active matrix substrates wherein TFTs are provided below the OLED layers. It is still necessary that the substrate, at least in the emissive pixilated areas, be comprised of largely transparent materials such as glass or polymers. For applications where the EL emission is viewed through the top electrode, the transmissive characteristic of the bottom support is immaterial, and therefore can be light transmissive, light absorbing or light reflective. Substrates for use in this case include, but are not limited to, glass, plastic, semiconductor materials, silicon, ceramics, and circuit board materials. Again, the substrate can be a complex structure comprising multiple layers of materials such as found in active matrix TFT designs. It is necessary to provide in these device configurations a light-transparent top electrode.

Anode

When the desired electroluminescent light emission (EL) is viewed through the anode, the anode should be transparent or substantially transparent to the emission of interest. Common transparent anode materials used in this invention are indium-tin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode. For applications where EL emission is viewed only through the cathode, the transmissive characteristics of the anode are immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means. Anodes can be patterned using well-known photolithographic processes. Optionally, anodes may be polished prior to application of other layers to reduce surface roughness so as to minimize shorts or enhance reflectivity.

Cathode

When light emission is viewed solely through the anode, the cathode used in this invention can be comprised of nearly any conductive material. Desirable materials have good film-forming properties to ensure good contact with the underlying organic layer, promote electron injection at low voltage, and have good stability. Useful cathode materials often contain a low work function metal (<4.0 eV) or metal alloy. One useful cathode material is comprised of a Mg:Ag alloy wherein the percentage of silver is in the range of 1 to 20%, as described in U.S. Pat. No. 4,885,221. Another suitable class of cathode materials includes bilayers comprising the cathode and a thin electron-injectioning layer (EIL) in contact with an organic layer (e.g., an electron-transporting layer (ETL)) which is capped with a thicker layer of a conductive metal. Here, the EIL preferably includes a low work function metal or metal salt, and if so, the thicker capping layer does not need to have a low work function. One such cathode is comprised of a thin layer of LiF followed by a thicker layer of Al as described in U.S. Pat. No. 5,677,572. An ETL material doped with an alkali metal, for example, Li-doped Alq, is another example of a useful EIL. Other useful cathode material sets include, but are not limited to, those disclosed in U.S. Pat. Nos. 5,059,861, 5,059,862, and 6,140,763.

When light emission is viewed through the cathode, the cathode must be transparent or nearly transparent. For such applications, metals must be thin or one must use transparent conductive oxides, or a combination of these materials. Optically transparent cathodes have been described in more detail in U.S. Pat. No. 4,885,211, U.S. Pat. No. 5,247,190, JP 3,234,963, U.S. Pat. No. 5,703,436, U.S. Pat. No. 5,608,287, U.S. Pat. No. 5,837,391, U.S. Pat. No. 5,677,572, U.S. Pat. No. 5,776,622, U.S. Pat. No. 5,776,623, U.S. Pat. No. 5,714,838, U.S. Pat. No. 5,969,474, U.S. Pat. No. 5,739,545, U.S. Pat No. 5,981,306, U.S. Pat. No. 6,137,223, U.S. Pat. No. 6,140,763, U.S. Pat. No. 6,172,459, EP 1 076 368, U.S. Pat. No. 6,278,236, and U.S. Pat. No. 6,284,3936. Cathode materials are typically deposited by any suitable method such as evaporation, sputtering, or chemical vapor deposition. When needed, patterning can be achieved through many well known methods including, but not limited to, through-mask deposition, integral shadow masking as described in U.S. Pat. No. 5,276,380 and EP 0 732 868, laser ablation, and selective chemical vapor deposition.

Hole-Injecting Layer (HIL)

A hole-injecting layer 105 may be provided between anode 103 and hole-transporting layer 107. The hole-injecting material can serve to improve the film formation property of subsequent organic layers and to facilitate injection of holes into the hole-transporting layer. Suitable materials for use in the hole-injecting layer include, but are not limited to, porphyrinic compounds as described in U.S. Pat. No. 4,720,432, plasma-deposited fluorocarbon polymers as described in U.S. Pat. No. 6,208,075, and some aromatic amines, for example, m-MTDATA (4,4′,4″-tris[(3-methylphenyl)phenylamino]triphenylamine). Alternative hole-injecting materials reportedly useful in organic EL devices are described in EP 0 891 121 A1 and EP 1 029 909 A1.

Hole-Transporting Layer (HTL)

The hole-transporting layer 107 of the organic EL device contains at least one hole-transporting compound such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. U.S. Pat. No. 3,180,730. Other suitable triarylamines substituted with one or more vinyl radicals and/or comprising at least one active hydrogen containing group are disclosed by Brantley et al U.S. Pat. No. 3,567,450 and U.S. Pat. No. 3,658,520.

A more preferred class of aromatic tertiary amines are those which include at least two aromatic tertiary amine moieties as described in U.S. Pat. No. 4,720,432 and U.S. Pat. No. 5,061,569. Such compounds include those represented by structural formula (A). 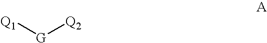
wherein Q₁ and Q₂ are independently selected aromatic tertiary amine moieties and G is a linking group such as an arylene, cycloalkylene, or alkylene group of a carbon to carbon bond. In one embodiment, at least one of Q₁ or Q₂ contains a polycyclic fused ring structure, e.g., a naphthalene. When G is an aryl group, it is conveniently a phenylene, biphenylene, or naphthalene moiety.

A useful class of triarylamines satisfying structural formula (A) and containing two triarylamine moieties is represented by structural formula (B): 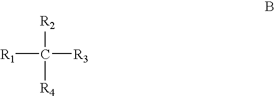
where
R₁ and R₂ each independently represents a hydrogen atom, an aryl group, or an alkyl group or R₁ and R₂ together represent the atoms completing a cycloalkyl group; and
R₃ and R₄ each independently represents an aryl group, which is in turn substituted with a diaryl substituted amino group, as indicated by structural formula (C): 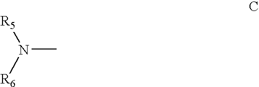
   wherein R₅ and R₆ are independently selected aryl groups. In one embodiment, at least one of R₅ or R₆ contains a polycyclic fused ring structure, e.g., a naphthalene.

Another class of aromatic tertiary amines are the tetraaryldiamines. Desirable tetraaryldiamines include two diarylamino groups, such as indicated by formula (C), linked through an arylene group. Useful tetraaryldiamines include those represented by formula (D). 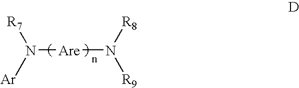
wherein
each Are is an independently selected arylene group, such as a phenylene or anthracene moiety,
n is an integer of from 1 to 4, and
Ar, R₇, R₈, and R₉ are independently selected aryl groups.
In a typical embodiment, at least one of Ar, R₇, R₈, and R₉ is a polycyclic fused ring structure, e.g., a naphthalene

The various alkyl, alkylene, aryl, and arylene moieties of the foregoing structural formulae (A), (B), (C), (D), can each in turn be substituted. Typical substituents include alkyl groups, alkoxy groups, aryl groups, aryloxy groups, and halogen such as fluoride, chloride, and bromide. The various alkyl and alkylene moieties typically contain from about 1 to 6 carbon atoms. The cycloalkyl moieties can contain from 3 to about 10 carbon atoms, but typically contain five, six, or seven ring carbon atoms—e.g., cyclopentyl, cyclohexyl, and cycloheptyl ring structures. The aryl and arylene moieties are usually phenyl and phenylene moieties.

The hole-transporting layer can be formed of a single or a mixture of aromatic tertiary amine compounds. Specifically, one may employ a triarylamine, such as a triarylamine satisfying the formula (B), in combination with a tetraaryldiamine, such as indicated by formula (D). When a triarylamine is employed in combination with a tetraaryldiamine, the latter is positioned as a layer interposed between the triarylamine and the electron injecting and transporting layer. Illustrative of useful aromatic tertiary amines are the following:
1,1-Bis(4-di-p-tolylaminophenyl)cyclohexane
1,1-Bis(4-di-p-tolylaminophenyl)-4-phenylcyclohexane
N,N,N′,N′-tetraphenyl-4,4′″-diamino-1,1′:4′,1″:4″,1′″-quaterphenyl
Bis(4-dimethylamino-2-methylphenyl)phenylmethane
1,4-bis[2-[4-[N,N-di(p-toly)amino]phenyl]vinyl]benzene (BDTAPVB)
N,N,N′,N′-Tetra-p-tolyl-4,4′-diaminobiphenyl
N,N,N′,N′-Tetraphenyl-4,4′-diaminobiphenyl
N,N,N′,N′-tetra-1-naphthyl-4,4′-diaminobiphenyl
N,N,N′,N′-tetra-2-naphthyl-4,4′-diaminobiphenyl
N-Phenylcarbazole
4,4′-Bis[N-(1-naphthyl)-N-phenylamino]biphenyl (NPB)
4,4′-Bis[N-(1-naphthyl)-N-(2-naphthyl)amino]biphenyl (TNB)
4,4′-Bis[N-(1-naphthyl)-N-phenylamino]p-terphenyl
4,4′-Bis[N-(2-naphthyl)-N-phenylamino]biphenyl
4,4′-Bis[N-(3-acenaphthenyl)-N-phenylamino]biphenyl
1,5-Bis[N-(1-naphthyl)-N-phenylamino]naphthalene
4,4′-Bis[N-(9-anthryl)-N-phenylamino]biphenyl
4,4′-Bis[N-(1-anthryl)-N-phenylamino]-p-terphenyl
4,4′-Bis[N-(2-phenanthryl)-N-phenylamino]biphenyl
4,4′-Bis[N-(8-fluoranthenyl)-N-phenylamino]biphenyl
4,4′-Bis[N-(2-pyrenyl)-N-phenylamino]biphenyl
4,4′-Bis[N-(2-naphthacenyl)-N-phenylamino]biphenyl
4,4′-Bis[N-(2-perylenyl)-N-phenylamino]biphenyl
4,4′-Bis[N-(1-coronenyl)-N-phenylamino]biphenyl
2,6-Bis(di-p-tolylamino)naphthalene
2,6-Bis[di-(1-naphthyl)amino]naphthalene
2,6-Bis[N-(1-naphthyl)-N-(2-naphthyl)amino]naphthalene
N,N,N′,N′-Tetra(2-naphthyl)-4,4″-diamino-p-terphenyl
4,4′-Bis{N-phenyl-N-[4-(1-naphthyl)-phenyl]amino}biphenyl
2,6-Bis[N,N-di(2-naphthyl)amino]fluorene
4,4′,4″-tris[(3-methylphenyl)phenylamino]triphenylamine (MTDATA)
4,4′-Bis[N-(3-methylphenyl)-N-phenylamino]biphenyl (TPD)

Another class of useful hole-transporting materials includes polycyclic aromatic compounds as described in EP 1 009 041. Tertiary aromatic amines with more than two amine groups may be used including oligomeric materials. In addition, polymeric hole-transporting materials can be used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS.

Light-Emitting Materials and Layers (LEL)

Suitable light-emitting materials and layers have been described above.

Electron-Transporting Layer (ETL)

Preferred thin film-forming materials for use in forming the electron-transporting layer 111 of the organic EL devices of this invention are metal chelated oxinoid compounds, including chelates of oxine itself (also commonly referred to as 8-quinolinol or 8-hydroxyquinoline). Such compounds help to inject and transport electrons and exhibit both high levels of performance and are readily fabricated in the form of thin films. Exemplary of contemplated oxinoid compounds are those satisfying structural formula (E), previously described.

Other electron-transporting materials include various butadiene derivatives as disclosed in U.S. Pat. No. 4,356,429 and various heterocyclic optical brighteners as described in U.S. Pat. No. 4,539,507. Benzazoles satisfying structural formula (G) are also useful electron transporting materials. Triazines are also known to be useful as electron transporting materials.

Other Useful Organic Layers and Device Architecture

In some instances, layers 109 through 111 can optionally be collapsed into a single layer that serves the function of supporting both light emission and electron transport. Layers 110 and 111 may also be collapsed into a single layer that functions to block holes or excitons, and supports electron transport. It also known in the art that emitting materials may be included in the hole-transporting layer, which may serve as a host.

This invention may be used in so-called stacked device architecture, for example, as taught in U.S. Pat. No. 5,703,436 and U.S. Pat. No. 6,337,492.

Deposition of Organic Layers

The organic materials mentioned above are suitably deposited by any means suitable for the form of the organic materials. In the case of small molecules, they are conveniently deposited through sublimation, but can be deposited by other means such as from a solvent with an optional binder to improve film formation. If the material is a polymer, solvent deposition is usually preferred. The material to be deposited by sublimation can be vaporized from a sublimator “boat” often comprised of a tantalum material, e.g., as described in U.S. Pat. No. 6,237,529, or can be first coated onto a donor sheet and then sublimed in closer proximity to the substrate. Layers with a mixture of materials can utilize separate sublimator boats or the materials can be pre-mixed and coated from a single boat or donor sheet. Patterned deposition can be achieved using shadow masks, integral shadow masks (U.S. Pat. No. 5,294,870), spatially-defined thermal dye transfer from a donor sheet (U.S. Pat. No. 5,688,551, U.S. Pat. No. 5,851,709 and U.S. Pat. No. 6,066,357) and inkjet method (U.S. Pat No. 6,066,357).

Encapsulation

Most OLED devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890. In addition, barrier layers such as SiOx, Teflon, and alternating inorganic/polymeric layers are known in the art for encapsulation.

Optical Optimization

OLED devices of this invention can employ various well-known optical effects in order to enhance its properties if desired. This includes optimizing layer thicknesses to yield maximum light transmission, providing dielectric mirror structures, replacing reflective electrodes with light-absorbing electrodes, providing anti-glare or anti-reflection coatings over the display, providing a polarizing medium over the display, or providing colored, neutral density, or color-conversion filters over the display. Filters, polarizers, and anti-glare or anti-reflection coatings may be specifically provided over the cover or as part of the cover.

### EXAMPLES

The invention and its advantages can be better appreciated by the following examples.

### Synthetic Example 1

### The Synthesis of 3-Phenylisoquinoline and Iridium Complexes of 3-Phenylisoquinoline

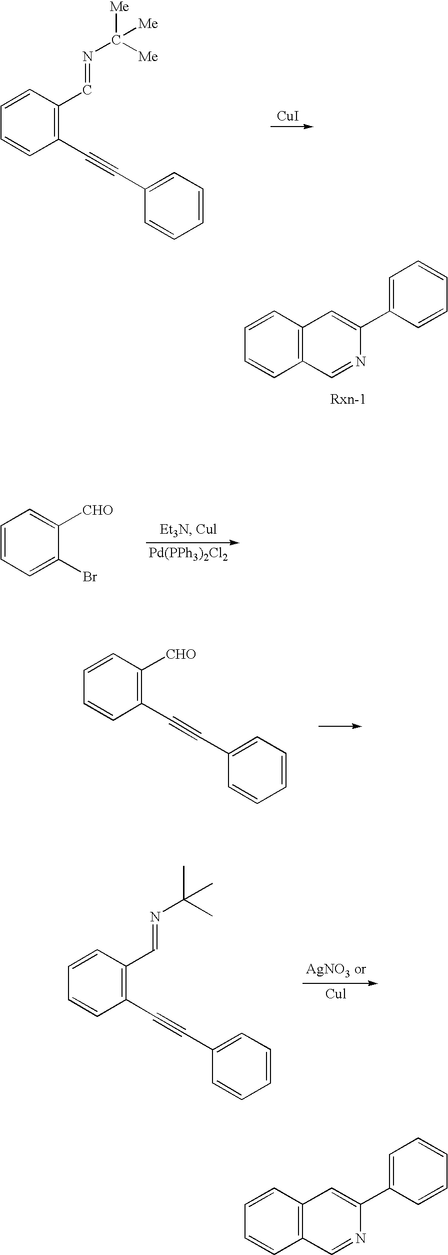

3-Phenylisoquinoline was prepared by the following procedure (see Huang et al., J. Org. Chem. 67, 3437 (2000), Rxn-1). A round bottom flask containing N-(2-phenylethynylbenzylidene)-t-butyl-amine (12.7 g, 48.6 mmol) was dissolved in anhydrous DMF under a nitrogen blanket. Cuprous iodide was added and the reaction vessel was warmed to 100° C. After three hours, thin layer chromatography (dichloromethane eluant) indicated no remaining starting material. One major product was formed. The reaction mixture was cooled to room temperature and the DMF removed by distillation. The residue was taken up in dichloromethane and washed with water, brine and the organic solution dried over magnesium sulfate. Solvents were evaporated to yield 9.9 grams of crude product. This material was further purified by flash chromatography on 800 grams of silica-gel with dichloromethane as eluant. The collected fractions were combined and recrystallized from heptane to yield 7.8 grams of 3-phenylisoquinoline as a beige solid. Spectral analysis was consistent with that reported by Huang et al.

Tetrakis(3-phenyl-isoquinolinato)(di-μ-bromo)diiridium(III) was prepared by the following procedure. K₃IrBr₆ (5.90 g) and 3-phenyl-isoquinoline (4.22 g) were combined in a 200 mL round bottom flask with 2-ethoxy-ethanol (45 mL) and water (15 mL). The mixture was freeze-thaw degassed and then refluxed under nitrogen atmosphere for four hours. After cooling, the orange precipitate was filtered in air, washed with 1 M HBr(aq), then water, and dried (4.77 g). The product was used without further purification in the next reaction.

Bis(3-phenyl-isoquinolinato)iridium(III)(acetylacetonate) was prepared by the following procedure. Tetrakis(3-phenyl-isoquinolinato)(di-1-bromo)diiridium(III) (1.93 g) and sodium acetylacetonate hydrate (1.20 g) were combined in a 100 mL round bottom flask with 30 mL 1,2-dichloroethane. The mixture was freeze-thaw degassed and then refluxed under nitrogen atmosphere for 20 h. After cooling, the reaction mixture was filtered in air. The orange filtrate was concentrated on a rotary evaporator, and then an orange solid was precipitated by addition of hexanes. The orange powder was filtered and dried (1.803 g). The product was characterized by mass spectral analysis and HPLC. A portion of the product was sublimed at 270° C. in a tube furnace with nitrogen entrainment gas for use in device fabrication in the examples below, while another portion of this product was used without further purification in the next reaction.

fac-Tris(3-phenyl-isoquinolinato)iridium(III) was prepared by the following procedure. Bis(3-phenyl-isoquinolinato)iridium(III)(acetylacetonate) (0.609 g) and 3-phenylisoquinoline (0.446 g) were combined in a 100 mL round bottom flask with 30 mL 1,3-butanediol. The reaction mixture was freeze-thaw degassed and then refluxed under nitrogen atmosphere for 60 hours. After cooling, the reaction mixture was filtered in air. The orange precipitate was washed with deionized water and dried (0.291 g). The product was characterized by mass spectral analysis and HPLC analysis. A portion of the product was sublimed at 330° C. in a tube furnace with nitrogen entrainment gas for use in device fabrication examples below. Analysis by single-crystal x-ray diffraction revealed that the product was the facial isomer of tris(3-phenyl-isoquinolinato)iridium(III).

### Device Example 1

### Evaluation of Phosphorescent Light Emitting Materials

Phosphorescent light-emitting materials were evaluated to determine if they would provide good operating lifetimes and hues. An EL device (Sample 1) was constructed in the following manner:

1. A glass substrate coated with an 85 nm layer of indium-tin oxide (ITO) as the anode was sequentially ultrasonicated in a commercial detergent, rinsed in deionized water, degreased in toluene vapor and exposed to oxygen plasma for about 1 min.

2. Over the ITO was deposited a 1 nm fluorocarbon (CFx) hole-injecting layer (HIL) by plasma-assisted deposition of CHF₃.

A hole-transporting layer (HTL) of N,N′-di-1-naphthyl-N,N′-diphenyl-4,4′-diaminobiphenyl (NPB) having a thickness of 75 nm was then evaporated from a tantalum boat.

3. A 35 nm light-emitting layer (LEL) of 4,4′-N,N′-dicarbazole-biphenyl (7a, CBP) and 8 wt. % fac-tris(3-phenyl-isoquinolinato) iridium (III) were then deposited onto the hole-transporting layer. These materials were also evaporated from tantalum boats.

4. A hole-blocking layer of bis(2-methyl-quinolinolato)(4-phenylphenolato) aluminum(III) (BAlq) having a thickness of 10 nm was then evaporated from a tantalum boat.

5. A 40 nm electron-transporting layer (ETL) of tris(8-quinolinolato)aluminum (III) (AlQ₃) was then deposited onto the light-emitting layer. This material was also evaporated from a tantalum boat. On top of the AlQ₃ layer was deposited a 220 nm cathode formed of a 10:1 volume ratio of Mg and Ag.

The above sequence completed the deposition of the EL device. The device was then hermetically packaged in a dry glove box for protection against ambient environment.

A second EL device (Sample 2) was prepared in the same manner as Sample 1 except the light-emitting material used in the LEL was bis(3-phenyl-isoquinolinato)iridium(III) acetylacetonate.

A third EL device (Sample 3) was prepared in the same manner as Sample 1 except the light-emitting material used in the LEL was fac-tris-(2-(2′-benzothienyl)pyridinato)Ir(III)

A fourth EL device (Sample 4) was prepared in the same manner as Sample 1 except the light-emitting material used in the LEL was mer-tris-(2-(2′-benzothienyl)pyridinato)Ir(III).

A fifth EL device (Sample 5) was prepared in the same manner as Sample 1 except the light-emitting material used in the LEL was bis-(2-(2′-benzothienyl)pyridinato)Ir(III)(acetylacetonate).

A sixth EL device (Sample 6) was prepared in the same manner as Sample 1 except the light-emitting material used in the LEL was fac-tris-(2-phenyl-benzothiazolato)Ir(III).

A seventh EL device (Sample 7) was prepared in the same manner as Sample 1 except the light-emitting material used in the LEL was bis-(2-phenyl-benzothiazolato)Ir(III)(acetylacetonate).

A eighth EL device (Sample 8) was prepared in the same manner as Sample 1 except the light-emitting material used in the LEL was bis-(2-phenyl-quinolinato)Ir(III)(acetylacetonate).

A ninth EL device (Sample 9) was prepared in the same manner as Sample 1 except the light-emitting material used in the LEL was fac-tris-(2-(1-napthyl)pyridinato)Ir(III).

A tenth EL device (Sample 10) was prepared in the same manner as Sample 1 except the light-emitting material used in the LEL was fac-tris-(2-(2-napthyl)pyridinato)Ir(III).

Through additional experimentation varying the level of the phosphorescent compounds, the optimum performance was found in the range 4 to 8% for each phosphorescent compound. The cells thus formed were tested for luminous efficiency and color at an operating current of 20 mA/cm² and the results are reported in Table 1 in the form of luminance yield (cd/A) and 1931 CIE (Commission Internationale de L'Eclairage) coordinates. The operational stability of these devices was also tested at a current density of 20 mA/cm². The time for operating devices to fade to one half the initial luminance is also reported in Table 1.

TABLE 1
Evaluation of the performance of phosphorescent materials.

| | Emission | Yield | | | Stability |
|---|---|---|---|---|---|
| Sample | Max (nm) | (Cd/A) | CIE(X) | CIE(Y) | T_{1/2}(h) |
| 1 | 572 | 19.40 | 0.536 | 0.461 | 957 |
| 2 | 564 | 22.10 | 0.520 | 0.475 | 58 |
| 3 | 600 | 4.36 | 0.609 | 0.372 | 46 |
| 4 | 600 | 4.84 | 0.630 | 0.359 | 30 |
| 5 | 620 | 3.18 | 0.664 | 0.322 | 64 |
| 6 | 552 | 8.63 | 0.453 | 0.517 | 13 |
| 7 | 564 | 12.63 | 0.499 | 0.484 | 38 |
| 8 | 600 | 15.62 | 0.604 | 0.390 | 172 |
| 9 | 588 | 8.06 | 0.586 | 0.408 | 285 |
| 10 | 556 | 13.24 | 0.465 | 0.525 | 307 |

The results in Table 1 indicates that devices containing 3-phenyl-isoquinolinato complexes of Ir(III) (Samples 1 and 2) compared to the other devices gave high luminance yield, as well as a hue that is suitable for combining with other dopants to produce a white electroluminescent. Further, it is seen that the fac-tris(3-phenyl-isoquinolinato)iridium(III) compound is particularly desirable because it gave an electroluminescent test device with markedly higher stability than the other emissive compounds.

### Device Example 2

An EL device (Sample 11) satisfying the requirements of the invention was constructed in the following manner:

1. A glass substrate coated with an 85 nm layer of indium-tin oxide (ITO) as the anode was sequentially ultrasonicated in a commercial detergent, rinsed in deionized water, degreased in toluene vapor and exposed to oxygen plasma for about 1 min.

2. Over the ITO was deposited a 1 nm fluorocarbon (CFx) hole-injecting layer (HIL) by plasma-assisted deposition of CHF₃.

3. A hole-transporting layer (HTL)of N,N′-di-1-naphthyl-N,N′-diphenyl-4,4′-diaminobiphenyl (NPB) having a thickness of 95 nm was then evaporated from a tantalum boat.

4. A 20 nm first light-emitting layer (LEL) of host 8c and 2.5 wt. % blue light-emitting material (5c) were then deposited onto the hole-transporting layer. These materials were also evaporated from tantalum boats.

5. A 20 nm second LEL of 4,4′-N,N′-dicarbazole-biphenyl (7a, CBP) and 8 wt. % fac-tris(3-phenyl-isoquinolinato)iridium(III) were then deposited onto the first LEL. These materials were also evaporated from tantalum boats.

6. A hole-blocking layer of bis(2-methyl-quinolinolato)(4-phenylphenolato) aluminum(II) (BAlq) having a thickness of 10 nm was then evaporated from a tantalum boat.

7. A 40 nm electron-transporting layer (ETL) of tris(8-quinolinolato)aluminum (III) (AlQ₃) was then deposited onto the light-emitting layer. This material was also evaporated from a tantalum boat.

8. On top of the AlQ₃ layer was deposited a 220 nm cathode formed of a 10:1 volume ratio of Mg and Ag.

The above sequence completed the deposition of the EL device. The device was then hermetically packaged in a dry glove box for protection against ambient environment.

The device thus formed was tested for luminous efficiency and color at an operating current of 20 mA/cm² and the results were reported in the form of luminance yield (cd/A) and 1 CIE coordinates. The EL spectrum was comprised of the emission spectra of the fluorescent blue dopant and of the yellow phosphorescent dopant and was reflected in the observed CIE (X,Y) coordinates of (0.383, 0.479). This color is suitable, after appropriate filtration, for a white light-emitting device. The luminous yield was 9.65 cd/A.

### Device Example 3

An EL device (Sample 12) satisfying the requirements of the invention was constructed in the following manner:

1. A glass substrate coated with an 85 nm layer of indium-tin oxide (ITO) as the anode was sequentially ultrasonicated in a commercial detergent, rinsed in deionized water, degreased in toluene vapor and exposed to oxygen plasma for about 1 min.

2. Over the ITO was deposited a 1 nm fluorocarbon (CFx) hole-injecting layer (HIL) by plasma-assisted deposition of CHF₃.

3. A hole-transporting layer (HTL)of N,N′-di-1-naphthyl-N,N′-diphenyl-4,4′-diaminobiphenyl (NPB) having a thickness of 95 nm was then evaporated from a tantalum boat.

4. A 20 nm first light-emitting layer (LEL) of host 8b and 2.5% of blue light-emitting material 5c were then deposited onto the hole-transporting layer. These materials were also evaporated from tantalum boats.

5. A 20 nm second LEL of 4,4′-N,N′-dicarbazole-biphenyl (CBP) and 8% bis(3-phenyl-isoquinolinato)iridium(III)(acetylacetonate) were then deposited onto the first LEL. These materials were also evaporated from tantalum boats.

6. A hole-blocking layer of bis(2-methyl-quinolinolato)(4-phenylphenolato) aluminum(III) (BAlq) and 2.5% blue light-emitting material 5c having a thickness of 10 nm was then evaporated from a tantalum boat.

7. A 40 nm electron-transporting layer (ETL) of tris(8-quinolinolato)aluminum (III) (AlQ₃) was then deposited onto the light-emitting layer. This material was also evaporated from a tantalum boat.

8. On top of the AlQ₃ layer was deposited a 220 nm cathode formed of a 10:1 volume ratio of Mg and Ag.

The above sequence completed the deposition of the EL device. The device was then hermetically packaged in a dry glove box for protection against ambient environment.

The device thus formed was tested for luminous efficiency and color at an operating current of 20 mA/cM² and the results were reported in the form of luminance yield (cd/A) and CIE (Commission Internationale de L'Eclairage) coordinates. The EL spectrum was comprised of the emission spectra of the fluorescent blue light-emitting material and of the yellow phosphorescent light-emitting material and was reflected in the observed CIE (X,Y) coordinates of (0.337, 0.483). This color is suitable, after appropriate filtration, for a white light-emitting device. The luminous yield was 8.43 cd/A.

### Device Example 4

An EL device (Sample 13) satisfying the requirements of the invention was constructed in the following manner:

1. A glass substrate coated with an 85 nm layer of indium-tin oxide (ITO) as the anode was sequentially ultrasonicated in a commercial detergent, rinsed in deionized water, degreased in toluene vapor and exposed to oxygen plasma for about 1 min.

2. Over the ITO was deposited a 1 nm fluorocarbon (CFx) hole-injecting layer (HIL) by plasma-assisted deposition of CHF₃.

3. A hole-transporting layer (HTL)of N,N′-di-1-naphthyl-N,N′-diphenyl-4,4′-diaminobiphenyl (NPB) having a thickness of 95 nm was then evaporated from a tantalum boat.

4. A 10 nm first light-emitting layer (LEL) of Host 8b and 2.5% blue light-emitting material 5c were then deposited onto the hole-transporting layer. These materials were also evaporated from tantalum boats.

5. A 20 nm second LEL of 4,4′-N,N′-dicarbazole-biphenyl (CBP) and 8% bis(3-phenyl-isoquinolinato)iridium(III)(acetylacetonate) were then deposited onto the first LEL. These materials were also evaporated from tantalum boats.

6. A 10 nm third LEL of host 8b and 2.5% blue light-emitting material 5c were then deposited onto the hole-transporting layer. These materials were also evaporated from tantalum boats.

7. A hole-blocking layer of bis(2-methyl-quinolinolato)(4-phenylphenolato) aluminum(III) (BAlq) having a thickness of 10 nm was then evaporated from a tantalum boat.

8. A 40 nm electron-transporting layer (ETL) of tris(8-quinolinolato)aluminum (III) (AlQ₃) was then deposited onto the light-emitting layer. This material was also evaporated from a tantalum boat.

9. On top of the AlQ₃ layer was deposited a 220 nm cathode formed of a 10:1 volume ratio of Mg and Ag.

The above sequence completed the deposition of the EL device. The device was then hermetically packaged in a dry glove box for protection against ambient environment.

The device thus formed was tested for luminous efficiency and color at an operating current of 20 mA/cm² and the results were reported in the form of luminance yield (cd/A) and CIE coordinates. The EL spectrum was comprised of the emission spectra of the fluorescent blue-green dopant and of the yellow-orange phosphorescent dopant and was reflected in the observed CIE (X,Y) coordinates of (0.389, 0.474). This color is suitable, after appropriate filtration, for a white light-emitting device. The luminous yield was 9.09 cd/A.

### Device Example 5

An EL device (Sample 14) satisfying the requirements of the invention was constructed in the following manner:

1. A glass substrate coated with an 85 nm layer of indium-tin oxide (ITO) as the anode was sequentially ultrasonicated in a commercial detergent, rinsed in deionized water, degreased in toluene vapor and exposed to oxygen plasma for about 1 min.

2. Over the ITO was deposited a 1 nm fluorocarbon (CFx) hole-injecting layer (HIL) by plasma-assisted deposition of CHF₃.

3. A hole-transporting layer (HTL)of N,N′-di-1-naphthyl-N,N′-diphenyl-4,4′-diaminobiphenyl (NPB) having a thickness of 95 nm was then evaporated from a tantalum boat.

4. A 10 nm first light-emitting layer (LEL) of host material 8b and 2.5% light-emitting material 5c were then deposited onto the hole-transporting layer. These materials were also evaporated from tantalum boats.

5. A 20 nm second LEL of 4,4′-N,N′-dicarbazole-biphenyl (CBP) and 8% fac-tris(3-phenyl-isoquinolinato)iridium(III) were then deposited onto the first LEL. These materials were also evaporated from tantalum boats.

6. A hole-blocking layer of bis(2-methyl-quinolinolato)(4-phenylphenolato)aluminum(III) (BAlq) having a thickness of 10 nm was then evaporated from a tantalum boat.

7. A 40 nm electron-transporting layer (ETL) of tris(8-quinolinolato)aluminum (III) (AlQ₃) was then deposited onto the light-emitting layer. This material was also evaporated from a tantalum boat.

8. On top of the AlQ₃ layer was deposited a 220 nm cathode formed of a 10:1 volume ratio of Mg and Ag.

The above sequence completed the deposition of the EL device. The device was then hermetically packaged in a dry glove box for protection against ambient environment.

An EL device (Sample 15) satisfying the requirements of the invention was fabricated identical manner to Sample 15, except that the thickness of the AlQ₃ layer was 20 nm. The devices thus formed were tested for luminous efficiency and color at an operating current of 20 mA/cm² and the results are reported in the form of luminance yield (cd/A) and CIE coordinates. The EL spectra were comprised of the emission spectra of the fluorescent blue dopant and of the yellow-orange phosphorescent dopant. The results are shown in Table 2.

TABLE 2
Evaluation of the Samples 14 and 15.

| Sample | CIE(X) | CIE(Y) | Yield(Cd/A) |
|---|---|---|---|
| 14 | 0.386 | 0.457 | 7.63 |
| 15 | 0.274 | 0.383 | 6.39 |

The color of light emitted by Samples 14 and 15 is suitable, after appropriate filtration, for a white light-emitting device. However the color emitted by Sample 15 is more desirable because it would require less correction in order to obtain a true white emission. The difference in CIE coordinates for Sample 15 relative to those of Sample 14 show the effect that varying thickness of layers, other than the LEL, can have upon color coordinates. Without being restricted to any particular theory, these changes are dominantly the result of optical cavity effects of changing the distances of the LEL's to the other layer interfaces, in particular the distances to the reflective cathode and the glass substrate. It will be understood that further co-optimization of all layers in the cell could result in more desirable color coordinates.

### Device Example 6

An EL device (Sample 16) satisfying the requirements of the invention was constructed in the following manner:

1. A glass substrate coated with an 85 nm layer of indium-tin oxide (ITO) as the anode was sequentially ultrasonicated in a commercial detergent, rinsed in deionized water, degreased in toluene vapor and exposed to oxygen plasma for about 1 min.

2. Over the ITO was deposited a 1 nm fluorocarbon (CFx) hole-injecting layer (HIL) by plasma-assisted deposition of CHF₃.

3. A hole-transporting layer (HTL)of N,N′-di-1-naphthyl-N,N′-diphenyl-4,4′-diaminobiphenyl (NPB) having a thickness of 95 nm was then evaporated from a tantalum boat.

4. A 20 nm first light-emitting layer (LEL) of 4,4′-N,N′-dicarbazole-biphenyl (CBP) and 8% bis(3-phenyl-isoquinolinato)iridium(III)(acetylacetonate) were then deposited onto the hole-transporting layer. These materials were also evaporated from tantalum boats.

5. A 20 nm second LEL of 4,4′-N,N′-dicarbazole-biphenyl (7a, CBP) and 0.75% of a light-emitting boron complex, 6c, were then deposited onto the first LEL. These materials were also evaporated from tantalum boats.

6. A hole-blocking layer of bis(2-methyl-quinolinolato)(4-phenylphenolato) aluminum(III) (BAlq) having a thickness of 10 nm was then evaporated from a tantalum boat.

7. A 40 nm electron-transporting layer (ETL) of tris(8-quinolinolato)aluminum (III) (AlQ₃) was then deposited onto the light-emitting layer. This material was also evaporated from a tantalum boat.

8. On top of the AlQ₃ layer was deposited a 220 nm cathode formed of a 10:1 volume ratio of Mg and Ag.

The above sequence completed the deposition of the EL device. The device was then hermetically packaged in a dry glove box for protection against ambient environment.

The device thus formed was tested for luminous efficiency and color at an operating current of 20 mA/cm². The EL spectrum was comprised of the emission spectra of the fluorescent blue-green light-emitting material, 6c, and of the yellow-orange phosphorescent light-emitting material, bis(3-phenyl-isoquinolinato)iridium(III)(acetylacetonate), and was reflected in the observed CIE (X,Y) coordinates of (0.380, 0.369). This color is suitable, after appropriate filtration, for a white light-emitting device. The luminous yield was 7.10 cd/A.

The entire contents of the patents and other publications referred to in this specification are incorporated herein by reference. The invention has been described in detail with particular reference to certain preferred embodiments thereof, but it will be understood that variations and modifications can be effected within the spirit and scope of the invention.

Parts List

101 Substrate
103 Anode
105 Hole-Injecting layer (HIL)
107 Hole-Transporting layer (HTL)
109 Light-Emitting layer (LEL)
110 Hole-blocking layer (HBL)
111 Electron-Transporting layer (ETL)
113 Cathode

1. An electroluminescent device comprising a cathode and anode, and therebetween, at least two light-emitting layers wherein the first layer, layer A, comprises a phosphorescent light-emitting organometallic compound comprising iridium and an isoquinoline group and a second layer, layer B, comprising a light-emitting material.

2. The device of claim 1 wherein the light emitted from the device is white light either produced directly or by using filters.

3. The device of claim 1 wherein the isoquinoline group is substituted with an aromatic group in the 3-position, which further bonds to iridium.

4. The device of claim 1 wherein the isoquinoline group is a 3-arylisoquinoline group.

5. The device of claim 1 wherein the organometallic compound is represented by Formula 1, 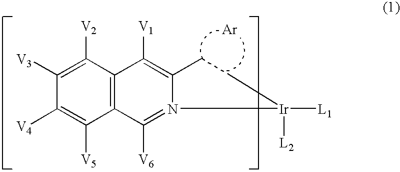
wherein:
Ar represents the atoms necessary to complete a five or six-membered aromatic ring;
L₁ and L₂ represent bidentate ligands; and
V₁-V₆ each independently represent hydrogen or an independently selected substituent, provided that adjacent substituents can join together to form a ring.

6. The device of claim 1 wherein the organometallic compound is represented by Formula 2, 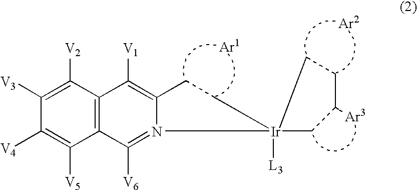
wherein:
Ar, Ar¹, and Ar² independently represent the atoms necessary to complete a five or six-memebered aromatic ring;
L₃ represents a bidentate ligand; and
V₁-V₆ each independently represent hydrogen or an independently selected substituent, provided that adjacent substituents can join together to form a ring.

7. The device of claim 1 wherein the organometallic compound is represented by Formula 3, 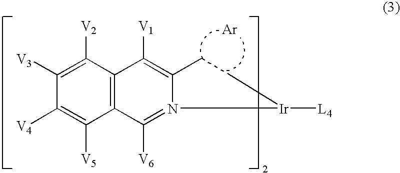
wherein:
Ar represents the atoms necessary to complete a five or six-memebered aromatic ring;
L₄ represents a ligand comprising a pyridine group substituted with a five or six-member aromatic group, wherein Ir bonds to both the pyridine group and the aromatic group; and
V₁-V₆ each independently represent hydrogen or an independently selected substituent, provided that adjacent substituents can join together to form a ring.

8. The device of claim 1 wherein the organometallic compound is represented by Formula 4, 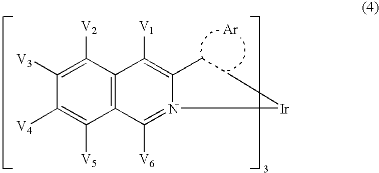
wherein:
Ar represents the atoms necessary to complete a five or six-membered aromatic ring; and
V₁-V₆ each independently represent hydrogen or independently selected substituents, provided that adjacent substituents can join together to form a ring.

9. The device of claim 1 wherein the layer B contains a fluorescent light-emitting material and a host for that material.

10. The device of claim 1 wherein the layer B contains a phosphorescent light-emitting material and a host for that material.

11. The device of claim 1 wherein layer B emits blue or blue-green light.

12. The device of claim 1 wherein layer A emits yellow light and layer B emits blue light.

13. The device of claim 1 wherein layer A emits red light.

14. The device of claim 1 wherein layer A emits red light and layer B emits blue-green light.

15. The device of claim 1 wherein layer A emits light with color defined by the following relationship between CIE x and y coordinates:
0.24*x+0.26<y<3*x−0.6.

16. The device of claim 1 wherein layer B emits light with color defined by the following relationship between CIE x and y coordinates:
2.4*x−0.43<y<−0.077*x+0.35.

17. The device of claim 1 wherein layer A emits light with color defined by the following relationship between CIE x and y coordinates:
0.24*X+0.26<y<3*x−0.6,
and layer B emits light with color defined by the following relationship:
2.4*x−0.43<y<−0.077*x+0.35.

18. The device of claim 1 wherein the relationship between the CIE color coordinates of light emitted by layer A and B is defined by equations (1) and (2):
y_{y}>(0.25−y_{b})/(0.31−x_{b})*x_{y}+(y_{b}*0.31−0.25*x_{b})/(0.31−x_{b}) (1)
y_{y}<(0.41−y_{b})/(0.31−x_{b})*x_{y}+(y_{b}*0.31−0.41*x_{b})/(0.31−x_{b}) (2)
wherein,
(x_{y}, y_{y}) represent the x and y color coordinates of light emitted by layer A,
(x_{b}, y_{b}) represent the x and y color coordinates of light emitted by layer B.

19. The device of claim 9 wherein the fluorescent material comprises a perylene group.

20. The device of claim 9 wherein the fluorescent material comprises a material of Formula 5a or Formula 5b, 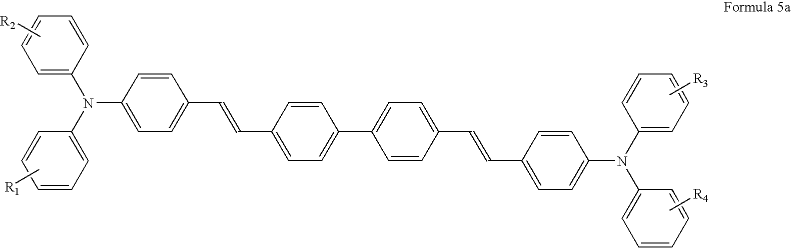 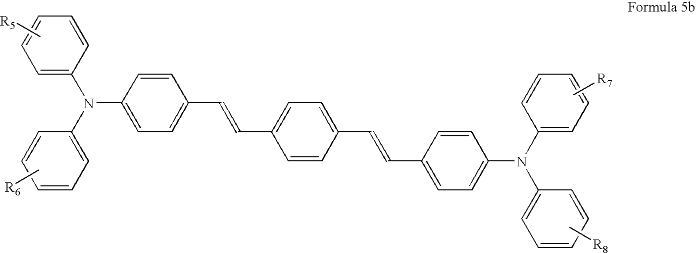
wherein:
R₁—R₈ independently represent hydrogen or an independently selected substituent.

21. The device of claim 9 wherein the fluorescent material comprises 1,4-bis[2-[4-[N,N-di(p-tolyl)amino]phenyl]vinyl]benzene (BDTAPVB) or 1,4-bis[2-[4-[N,N-di(p-tolyl)amino]phenyl]vinyl]biphenyl.

22. The device of claim 9 wherein the fluorescent material comprises a boron compound.

23. The device of claim 9 wherein the fluorescent material comprises a compound represented by formula 6a, 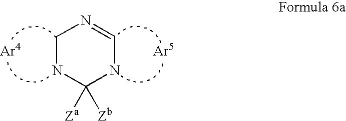
wherein:
Ar⁴ and Ar⁵ independently represent the atoms necessary to form an aromatic ring group; and
Z^{a} and Z^{b} represent independently selected substituents.

24. The device of claim 9 wherein the fluorescent material comprises a compound represented by Formula 6b, 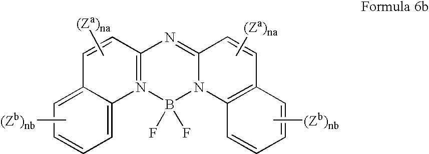
wherein:
each Z^{a} and Z^{b} represents independently selected substituents;
each na independently represents 0, 1, or 2; and
each nb independently represents 0-4.

25. The device of claim 9 wherein the host material is represented by Formula 7, 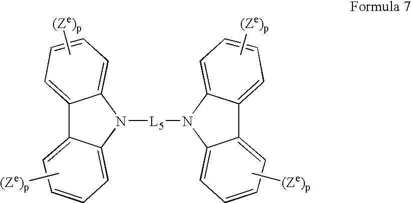
wherein:
each Z^{e} represents hydrogen or an independently selected substituent,
each p independently is 0-4;
L₅ is a phenylene group or a biphenylene group.

26. The device of claim 9 wherein the host material comprises an anthracene group.

27. The device of claim 9 wherein the host material is represented by Formula 8, 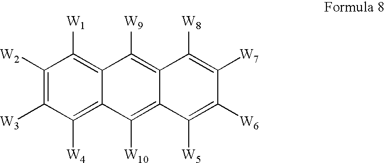
wherein:
W₁—W₁₀ independently represent hydrogen or an independently selected hydrocarbon substituent, provided that two adjacent substituents can combine to form rings.

28. The device of claim 27 wherein W₉ and W₁₀ of Formula 8 independently represent naphthyl or biphenyl groups.

29. The device of claim 27 wherein W₉ of Formula 8 represent a biphenyl groups.

30. The device of claim 1 wherein the phosphorescent material is between 2 and 15 wt % of the light-emitting layer A.

31. A display comprising the electroluminescent device of claim 1.

32. An area lighting device comprising the electroluminescent device of claim 1.

33. A process for emitting light comprising applying a potential across the device of claim 1.
